(19) United States
(12) Patent Application Publication
(10) Pub. No.: US 2021/0340809 A1
(43) Pub. Date: Nov. 4, 2021

(54) Built-In Transfer Hinge And Door-Window With Same

(71) Applicant: SHANDONG ZHENGHUA CONSTRUCTION TECHNOLOGY CO. LTD., Liaocheng, Shandong (CN)

(72) Inventors: Yangbin Du, Liaocheng, Shandong (CN); Yangji Du, Liaocheng, Shandong (CN); Huanli Jia, Liaocheng, Shandong (CN); Xiaomeng Du, Liaocheng, Shandong (CN); Huiying Du, Liaocheng, Shandong (CN)

(21) Appl. No.: 17/280,213

(22) PCT Filed: Apr. 21, 2020
(86) PCT No.: PCT/CN2020/085865

§ 371 Date: Mar. 26, 2021

(30) Foreign Application Priority Data
Aug. 16, 2019 (CN) 201910759255.9
Aug. 25, 2019 (CN) 201910787010.7
Nov. 8, 2019 (CN) 201911086026.1
Jan. 2, 2020 (CN) 202010001889.0

(51) Int. Cl. E06B 3/964; E06B 3/58; E05D 3/06

(52) U.S. Cl. CPC E06B 3/964; E05D 3/06; E06B 3/58

(57) ABSTRACT

Disclosed are a built-in transfer hinge, a side hung door-window mounted with the built-in transfer hinge, a mounting method thereof, a horizontal pivoting window mounted with the built-in transfer hinge, and a mounting method for a hardware hinge therein. The built-in transfer hinge includes a frame connecting block, a sash connecting block, a hinge body (12), a two-link rod (13), a three-link rod (14), and a clutch rod (15). The two-link rod (13) and the three-link rod (14) are connected to the frame connecting block. One end of the hinge body (12) is connected to the two-link rod (13), the middle of the hinge body (12) is connected to the three-link rod (14), and the other end of the hinge body (12) is connected to the sash connecting block. The clutch rod (15) is connected between the sash connecting block and the three-link rod (14).

### TECHNICAL FIELD

The present disclosure belongs to the technical field of building doors and windows, and in particular, to a built-in transfer hinge and a door-window with same.

### BACKGROUND

Most assembly hinges used in existing side hung doors and windows are surface-mounted folding pivot hinges and laminated hinge type hinges. Where, the hinges used for side hung doors are all surface-mounted folding pivot hinges, while side hung windows and horizontal pivoting windows may use the above-mentioned two types of hinges, namely, the surface-mounted folding pivot hinges and the laminated hinge type hinges.

The above-mentioned two types of hinges have different degrees of use function defects and physical performance substandard problems:

The first type of the surface-mounted folding pivot hinge is fixed and assembled by taking a hinge pivot as a center and making a hinge plate A and a hinge plate B of the hinge rotate around the pivot, so as to open and close a sash. However, the pivot must be designed outside a lap seam of the sash and a frame, which can avoid an interference between an end part of a window sash and a window frame when the window sash is opened or closed. The main disadvantages are as follows: (1) the hinges are made of metal materials and their structures are of L-shaped bodies; the hinges are connected to pivots from the interiors and have strong heat conduction phenomenon, which have obvious influence on an energy saving value K; (2) the surface-mounted folding pivot hinges have poor appearance attractiveness and poor visual effect; in addition, exposed outer sides may seriously interfere with side processes, such as applying a sealant and packaging a door opening.

The second type of laminated hinge type hinges belong to a hidden mounting manner, which are mainly applied to the side hung windows and the horizontal pivoting windows. The laminated hinge type hinges are based on a principle of multiple links, and are mounted in the cracks of the upper end and the lower end of the window sash. When the window sash is opened or closed, a main rod drives a V-shaped hinge to change the angle and opening length of the V-shaped hinge and drive the root of the window sash to move slightly in an opening direction. The main disadvantages are as follows: (1) the application objects may only be side hung window structures, so the application range is limited; (2) a supporting force of the V-shaped hinge in a hinge structure is limited, the V-shaped hinge bears a great weight when driving the window sash to open or close for a long time, so its service life is affected seriously; in addition, noise and resistance may be produced; (3) after the laminated hinge type hinge is mounted in the horizontal pivoting window, when the window sash is tilted inward, the sash needs to be tilted at 8 to 10 degrees around a lower hinge, the laminated hinge type hinge belongs to a stamping structure, which cannot match inward tilting, at the moment, there will be a hard injury.

It mainly includes cross connection, T-shaped connection, and corner connection when profiles are assembled and connected. In the cross connection and T-shaped connection in the prior art, the used connecting pieces further have the following disadvantages: (1) when the profiles are connected, there is a crack at a junction, which results in the reduction of the grade of the doors and windows and poor sealing performance; (2) the connecting strength is low, when the profiles are connected, the transverse connecting stability of the profiles is taken special consideration; the influence on the connecting piece and a connecting part caused by the self gravity of glass and the profile in the vertical direction are not considered, which results in the deformation of the profiles of the doors and windows after long-time use, and affects use.

In addition, a pressing line mounting position is a position that can be directly observed in a window, so its mounting effect directly affects the appearance quality of the overall window. In the prior art, it has been started to splice the pressing line on the window in a manner of connecting at 45 degrees. However, in the manner of connecting at 45 degrees in the prior art, there are the defects that a crack at an angle combining position is difficultly controlled to be small and the plane height difference is obvious; there are also the problems that an operation is complicated when the pressing line is mounted or detached, and the surface of the pressing line deforms easily to affect the quality of the window.

### SUMMARY

A built-in transfer hinge and a door-window with same provided by the present disclosure achieve the purposes of improving the sealing performance of the door-window, strengthening the connecting strength between a hardware structure and a frame profile and between the hardware structure and a sash profile, and improving the quality of the door-window and the attractiveness.

A built-in transfer hinge, including a frame connecting block, a sash connecting block, a two-link rod, a three-link rod, a hinge body, and a clutch rod. The hinge body is connected to the frame connecting block through the two-link rod and the three-link rod; the connecting positions of the two-link rod and the three-link rod on the hinge body are that: one end of the hinge body is connected to the two-link rod, the middle position of the hinge body is connected to the three-link rod, wherein the two sides of the hinge body are at a bending angle bounded by the position of the three-link rod, and the other end of the hinge body is connected to the sash connecting block; the clutch rod is further connected between the sash connecting block and the three-link rod.

Preferably, the frame connecting block is a first hinge seat and is mounted on a frame; the first hinge seat is that a first base body is connected to a cylindrical body, and the first base body and the cylindrical body are formed integrally; an arc-shaped hook bar is arranged at one of the two end parts of one side surface of the first base body, and an embedding mounting groove and a positioning bar are formed at the other of the two end parts of one side surface of the first base body; a groove is formed in a transverse position of the first base body; through pin holes are formed in upper walls and lower walls of two ends of the groove; a truncated position is formed on the cylindrical body, and through pin holes are respectively formed in an upper part and a lower part.

Preferably, the frame connecting block includes a hinge support and a second hinge seat; a groove is formed in the end part of the hinge support, and a pin shaft hole is formed in the hinge support; the structure of the second hinge seat includes a first convex shaft; the first convex shaft is mounted in the pin shaft hole to mount the second hinge seat in the groove; in the structure of the second hinge seat, an upward second convex shaft and a pin hole are further formed at one end; a two-link rod is mounted on the second convex shaft; a three-link rod is mounted in the pin hole of the second hinge seat.

Preferably, the sash connecting block is that a hinge block includes a second base body; two ends of one side of the second base body respectively form into arcs; on the other side, one end part is connected to a mounting bar and a hook-shaped mounting bar, and the other end part is provided with a protrusion part and a first pin hole; a second pin hole is formed in the second base body close to the first pin hole; gaps are formed in the centers of the positions of the first pin hole and the second pin hole; a gap position is also formed on the hook-shaped mounting bar.

Preferably, the sash connecting block is a pull rod, and the pull rod is connected between the clutch rod and the hinge body.

Preferably, in the frame, the structure of the frame profile includes: a first cavity, a first heat insulating cavity, and a second cavity; a first L-shaped wall and a second L-shaped wall respectively extend from two sides of an outer side wall of the first cavity; a first T-shaped wall and a second T-shaped wall respectively extend from two sides of a wall between the first cavity and the first heat insulating cavity; a third L-shaped wall extends from a wall between the second cavity and the first heat insulating cavity; a fourth L-shaped wall and a fifth L-shaped wall extend from an outer side wall of the second cavity;

in the sash, the structure of the sash profile includes: a third cavity, a second heat insulating cavity, and a fourth cavity; a sixth L-shaped wall extends from one of two sides of an outer side wall of the third cavity; a hook-shaped wall extends from the other side of the two sides of the outer side wall of the third cavity; a fourth T-shaped wall is arranged on the hook-shaped wall; a fifth T-shaped wall and a sixth T-shaped wall respectively extend from a wall between the third cavity and the second heat insulating cavity; a seventh L-shaped wall is arranged close to the hook-shaped wall between the fifth T-shaped wall and the hook-shaped wall; a concave groove is formed towards the cavity in the inner wall surface of the third cavity between the fifth T-shaped wall and the hook-shaped wall; an eighth L-shaped wall is formed on the wall between the second heat insulating cavity and the fourth cavity; the outer side wall of the fourth cavity extends to form a ninth L-shaped wall.

Preferably, first convex walls are respectively arranged at the opposite positions of the first L-shaped wall and the first T-shaped wall; a third T-shaped wall is arranged on the fifth L-shaped wall; a seventh T-shaped wall is formed on the ninth L-shaped wall; the second heat insulating cavity is externally connected to a sealing bar.

A side hung door-window mounted with the built-in transfer hinge includes a frame and a sash, wherein the frame is connected to the sash through the built-in transfer hinge;

in a first hinge seat, the arc-shaped hook bar is connected to the interior of the second L-shaped wall; an embedding strip is mounted in the embedding mounting groove, and the embedding mounting groove is fixed to the interior of the second T-shaped wall; a positioning bar is protruded at the position, in contact with the second L-shaped wall, on the first base body;

in a hinge block, two ends of one side of a second base body respectively form into arcs which are mounted between the fourth T-shaped wall and the seventh L-shaped wall; a mounting bar is mounted inside a transverse section of the seventh L-shaped wall; a hook-shaped mounting bar is mounted at the fifth T-shaped wall; solid walls with the same structures as that of the fifth T-shaped wall are formed in the hook-shaped parts at the two ends of a gap position formed by the hook-shaped mounting bar, and the solid walls are limiting fixing structures; the hinge block is fixed by a T-shaped embedding block within the space formed by the hook-shaped mounting bar and a wall of the fourth cavity;

the two-link rod and the three-link rod are respectively U-shaped, and pin holes are respectively formed in transverse walls and end parts, where clutch rod connecting pin holes are further formed in the inner side of the end parts of the three-link rod; a pin is mounted in the pin hole in the transverse wall of the two-link rod and the pin hole in the cylindrical body in a matched manner; a pin is mounted in the end part pin hole and the two-link rod connecting pin hole in the hinge body in a matched manner; a pin is mounted in the pin hole in the transverse wall of the three-link rod and the pin hole in the first base body in a matched manner; a pin is mounted in the end part pin hole and the three-link rod connecting pin hole in the hinge body in a matched manner; a position opening is formed in the position, corresponding to the two-link rod, in the wall of the second heat insulating cavity in the sash profile;

in a gap part of the hinge block, a pin is mounted in a first pin hole and a pin hole in one end of a clutch rod in a matched manner; a pin is mounted in a pin hole in the other end of the clutch rod and the clutch rod connecting pin hole of the three-link rod in a matched manner; a pin is mounted in a second pin hole and a hinge body connecting pin hole in a matched manner.

Preferably, the embedding strip includes a first transverse wall connected to a longitudinal wall and then connected to a second transverse wall. The second transverse wall is connected to a detaching wall; the length of the detaching wall is less than that of the overall embedding strip. A detaching working hole is further formed in the first base body; after the embedding strip is mounted, the detaching wall is located at a slightly upper part of the detaching working hole; the length of the formation part of a hinge block connecting pin hole is greater than that of other parts of a body.

Preferably, the side hung door-window mounted with the built-in transfer hinge further includes a mullion connecting structure. The mullion connecting structure includes a two-body connecting piece, a clamping bar connecting piece, and a pop-rivet. The two-body connecting piece includes two parts that are connected symmetrically. The structure of each part is that: a vertical pop-rivet half-hole is formed in a first side surface of the first base body, and a pin half-hole is formed in the transverse direction of the first base body; a groove is formed in the side surface opposite to the first side surface; the groove is divided into a first T-shaped diversion glue groove and a mounting groove; a diversion glue hole which is communicated with the pop-rivet half-hole is formed in an intersection position of the first T-shaped diversion glue groove; the bottom end of a longitudinal groove of the first T-shaped diversion glue groove is connected to the mounting groove; a diversion groove is formed in the junction of the mounting groove and the first T-shaped diversion glue groove, and the depth of the diversion groove is greater than that of the mounting groove; the diversion groove is connected to the longitudinal groove of the first T-shaped diversion glue groove, and extends through the mounting groove to connect a second diversion glue groove in the other side of the first base body; first convex walls are arranged on the two surfaces adjacent to the first side surface and are flush with the upper edge, close to one end of the first T-shaped diversion glue groove, of the mounting groove; the first convex walls extend to the bottom of the first base body at one end of the second diversion glue groove; the pop-rivet half-holes of the two parts form a pop-rivet mounting hole, and the two parts are connected to form a two-body connecting piece;

the structure of the clamping bar connecting piece includes a second base body and a pedestal; in the second base body, second T-shaped diversion glue grooves are respectively formed in one pair of opposite surfaces; a diversion glue hole is formed in one end, close to the transverse groove, in the longitudinal groove; fixing holes which penetrate through two surfaces are formed in the other pair of opposite surfaces; the fixing holes are communicated with the diversion glue hole; clamping grooves are formed in one side surface, perpendicular to the longitudinal groove of the second T-shaped diversion glue groove, provided with the second T-shaped diversion glue groove; two ends of the fixing clamping bar between the clamping grooves respectively extend in the length to form convex walls, the length of the second base body in contact with the clamping groove far away from the diversion glue hole is the same as that of the fixing clamping bar, and the convex walls are second convex walls; a slot is formed in the lower side of the second base body; the pedestal is mounted in the slot; the pedestal is T-shaped; third diversion glue grooves are respectively formed in the middle positions of a longitudinal part and a transverse part; the longitudinal part is mounted in the groove; the third diversion glue groove of the longitudinal part is connected to the second T-shaped diversion glue groove; the length of the transverse part is the same as that of the second base body.

The pop-rivet is a double-head pop-rivet: holes are formed in the two ends of the double-head pop-rivet; a diversion glue hole is formed in the direction perpendicular to the direction where the holes are located; the holes are communicated with the diversion glue hole; the pop-rivet is mounted in a pop-rivet mounting hole of the two-body connecting piece; the holes are overlapped with the hole formed by the pin half-holes; the diversion glue hole is overlapped with the diversion glue hole in the two-body connecting piece.

Preferably, in the first base body, a quarter arc gap is formed in the lower end of the first base body on a surface provided with the pop-rivet half-hole; the first T-shaped diversion glue groove, the second T-shaped diversion glue groove, the second diversion glue groove, and the third diversion glue groove are V-shaped grooves; the mounting groove is a rectangular groove; a chamfer is formed at the end part of the pop-rivet half-hole on one surface, provided with the second diversion glue groove, of the first base body.

Preferably, in the two-body connecting piece, the position of the diversion glue hole is closer to the end part of the first base body than the position of the pin half-hole; in the clamping bar connecting piece, the distance between the position of the diversion glue hole and the end part of the second base body is equal to that between the position of the fixing hole and the second base body; in the pop-rivet, the position of the diversion glue hole is closer to the end part of the pop-rivet than the position of the hole.

Preferably, the pop-rivet is a single-head pop-rivet: a hole and a diversion glue hole are formed in one end, and a rivet cap is arranged at the other end.

Preferably, the side hung door-window mounted with the built-in transfer hinge further includes a horizontal push type pressing line clamping seat. The horizontal push type pressing line clamping seat includes a base and an elastic hook body; a holding foot is formed at the front end of the lower side of the base, and an elastic hook is formed in the middle position of the holding foot; a Z-shaped body is arranged at the rear end of the lower side of the base; an outward folded hook is formed on the lower side of the Z-shaped body; an inward folded hook is formed on the upper side of the Z-shaped body; the side surface of the elastic hook body is Z-shaped; the front end of the elastic hook body is connected to the front end of the base, the overall elastic hook body surrounds the base; a crack is formed between the elastic hook body and the base; a hook bar is arranged on the upper surface of the elastic hook body.

Preferably, the base and the elastic hook body are integrally formed and are made of a nylon material; the holding foot is an arc-shaped block; a concave gap is formed in the base; the elastic hook is located at the concave gap; the front end of the holding foot is inclined backwards; the direction of the hook bar is backward; the top end of the hook bar is a rounded corner.

Preferably, the structure of a pressing line fixed by the clamping seat is that: the overall pressing line is tubular; an external corner is arc-shaped; the two walls connected to the external corner are respectively an outer surface and a back surface; the connecting wall between the outer surface and the back surface is a bottom surface; a hook bar is formed on the bottom surface; the direction of the hook bar of the pressing line faces the bottom surface; a groove is formed in the inner side of the back surface; two rubber strip hook bars are formed outside the groove.

Preferably, an angle combining piece is penetrated into a pressing line angle combining position; the angle combining piece is L-shaped; the surface of the angle combining piece is matched with an inner cavity of the pressed line; the surface of the angle combining piece is connected to a support wall; the angle combining piece is located in the groove after being mounted in the inner cavity of the pressed line.

A mounted method for the side hung door-window mounted with the built-in transfer hinge includes the following steps:

step 1: movably and fixedly mounting each of a first hinge seat, a hinge body, a hinge block, a two-link rod, a three-link rod, and a clutch rod by mounting pins in pin holes, so as to complete the assembling the overall hinge;

step 2: forming a notch with the same length as the positioning bar in a transverse wall of a second T-shaped wall at the position, corresponding to the positioning bar, where the first hinge seat is mounted on the frame; firstly, clamping the arc-shaped hook bar into a second L-shaped wall, and rotating a first base body around the arc-shaped hook bar to make a cylindrical body abut the second T-shaped wall; simultaneously, mounting the positioning bar into the notch, and penetrating the embedding strip into the embedding mounting groove, thereby mounting the first hinge seat on a frame profile;

step 3: at the position where the hinge block is mounted on the sash, clamping the hook-shaped mounting bar on the fifth T-shaped wall, and simultaneously, matching a solid wall structure with the fifth T-shaped wall; simultaneously, mounting an arc-shaped end part between the fourth T-shaped wall and the seventh L-shaped wall, and mounting a mounting bar inside the transverse section of the seventh L-shaped wall; penetrating the T-shaped embedding block into a space formed by the hook-shaped mounting bar and a wall of the fourth cavity to fix the hinge block; clamping the T-shaped embedding block between the fifth T-shaped wall and the mounting bar to mount the hinge block on the sash profile, thereby mounting the built-in transfer hinge on the side hung door-window to complete the mounting between the frame and the sash; in addition, when the first hinge seat is detached, penetrating a screw into the detaching working hole, and rotating to eject the embedding strip out.

Preferably, a connecting method for the mullion connecting structure includes the following steps:

step 1, cutting end surfaces of a mounting profile, namely, a second profile, required in T-shaped connection or cross connection, into planes according to required lengths, where the fifth L-shaped wall of the second profile is milled to adapt to the height of the fifth L-shaped wall of a first profile;

step 2: on a first profile, when the two-body connecting piece is connected, staggering the two parts of a two-body connecting body, and extruding to get close to a mounting position; connecting the two parts into the two-body connecting piece, making the second L-shaped wall engage with the second T-shaped wall outside the first cavity by the mounting groove; mounting the pop-rivet in the pop-rivet mounting hole of the two-body connecting piece after the pop-rivet penetrates through the first profile, and overlapping a hole of the pop-rivet with a hole formed by the pop-rivet half-holes, where a diversion glue hole in the pop-rivet is overlapped with a diversion glue hole in the two-body connecting piece; in cross connection, a double-head pop-rivet is used; in T-shaped connection, the single-head pop-rivet is used;

step 3, on the first profile, when the clamping bar connecting piece is connected, placing the pedestal into the bottom of the fifth L-shaped wall of the profile, and then, matching the position of the groove in the second base body and a longitudinal part of the pedestal; pushing and mounting the second base body at the fifth L-shaped wall of the second cavity through the clamping grooves, and clamping a fixing clamping bar between the transverse wall of the fifth L-shaped wall and the third T-shaped wall, where the clamping grooves respectively accommodate the transverse wall of the fifth L-shaped wall and the third T-shaped wall;

step 4, after the mounting of the two-body connecting piece and the clamping bar connecting piece is completed, mounting the profile that needs to be assembled, namely, the second profile; respectively sleeving the two-body connecting piece and the clamping bar connecting piece with the first cavity and the second cavity; respectively injecting glue into the pin hole and the fixing hole of the two-body connecting piece and the clamping bar connecting piece:

in the two-body connecting piece, glue may penetrate through the diversion glue hole in the pop-rivet, then enter the diversion glue hole in each part, reach a second diversion glue groove along the first T-shaped diversion glue groove, and then flow into a cavity formed at the chamber; whether the glue is full may be determined at a half arc gap;

in the clamping bar connecting piece, the glue may penetrate through the diversion glue hole and flow to the third diversion glue groove from the second T-shaped diversion glue groove; whether the glue is full may be determined at the clamping groove;

step 5: after glue injection is completed, respectively fixing pins in the pin hole of the two-body connecting piece and the fixing hole of the clamping bar connecting piece; fixing the second profile to form cross connection or T-shaped connection of profiles of a door-window; filling the junction of the second profile heat insulating cavity and the first profile with a sealing rubber strip,

where the first profile and the second profile may be a frame profile and a mullion profile respectively; in the mullion profile, the structures of two sides of each of a first cavity, a first heat insulating cavity, and a second cavity are in symmetrical distribution.

Preferably, a mounting and detaching method for the horizontal push type pressing line clamping seat includes the following steps:

firstly, regarding a glass side as an inner side, because a groove is formed in the door-window profile and L-shaped walls are formed at the two ends of the upper side of the groove, when the clamping seat is mounted in the groove, making the outward folded hook on the lower side of the Z-shaped body hook the sixth T-shaped wall, then pressing the base, making the holding foot fall into the groove, and hooking the sixth L-shaped wall by the elastic hook to complete the mounting of the clamping seat;

secondly, cutting a cross section of the pressing line into an inclination angle of 45 degrees, combining an angle by the angle combining piece to form a rectangular frame;

thirdly, mounting a pressing line frame which has been combined into a rectangle on a door-window profile in a horizontal push mounting manner; in a horizontal pushing process, making a pressing line hook bar of the pressing line move downwards elastically when the pressing line hook bar of the pressing line is in contact with a hook bar of an elastic hook body; when the pressing line hook bar crosses the hook bar of the elastic hook body, making the hook bar of the elastic hook body return, and fixing the pressing line hook bar under a combined action of the hook bar of the elastic hook body and an inward folded hook bar of the Z-shaped body;

finally, when the pressing line is detached and after a glass sealing strip is detached, pressing the elastic hook body by a tool, separating the hook bar of the elastic hook body from the pressing line hook bar, at this moment, the pressing line may be separated by pulling corresponding positions of the pressing line rectangular frame outwards; repeatedly pressing the subsequent elastic hook body, so that the pressing line rectangular frame is completely separated to complete the detaching of the pressing line.

A horizontal pivoting window mounted with the built-in transfer hinge includes a frame and a sash; a hardware transmission structure thereof includes a handle, wherein the profile of the handle toward the sash is internally connected to a transmission structure; two ends of the transmission structure are connected to transmission strips; the upper transmission strip is connected to a first side upper locking structure at an upper corner of the sash; the lower transmission strip is connected to a first side lower locking structure at a lower corner of the sash;

in the first side upper locking structure, the upper transmission strip is connected to an upper locking block through a pin shaft and pin hole matched structure; the other end of the upper locking block penetrates into a first angle sensor, and drives within the first angle sensor; an upper lock cylinder is arranged at an edge position on the upper locking block, an upper lock point is mounted on a frame corresponding to a locking position of the upper lock cylinder; an upper locking block penetrates into one end in a first angle sensor; multiple safety grooves are formed in an outer surface of the upper locking block; a safety shifting fork further extends out from the first angle sensor; a bulge is formed at an extension end of the safety shifting fork and is matched in the safety groove; at a safety shifting fork mounting position, a waist-shaped groove is formed in the first angle sensor, and a buckle cover is mounted on the waist-shaped groove; a convex shaft is formed in the waist-shaped groove; a cylindrical bulge is formed close to the convex shaft, the safety shifting fork is mounted on the convex shaft, and two limiting bulges are further formed on the safety shifting fork; a spring bypasses the cylindrical bulge; two ends of the spring are clamped between the two limiting bulges; in the first angle sensor, a transmission belt which is connected to the upper locking block bypasses the first angle sensor and is connected to a transmission strip on the upper side of the sash; the transmission strip is connected to a transmission rod; the transmission rod drives in the second angle sensor;

on a second angle sensor, a pull rod is mounted, and one end of the pull rod is assembled and connected to a built-in transfer hinge on the upper side; an arc-shaped notch is formed in one side of the upper surface of the second angle sensor; a waist-shaped groove is formed adjacent to the arc-shaped notch; one end of a limiting spring is mounted in the arc-shaped notch, and the other end of the limiting spring penetrates into the waist-shaped groove and forms elastic limiting; a pull rod pin is arranged in the limiting spring in a sleeving manner; the pull rod pin is fixedly connected to the pull rod; the middle position of the upper surface of the second angle sensor is connected to a reset rod; the other end of the reset rod is connected to the lower surface of the pull rod; a strip-shaped groove is formed in the other side of the upper surface of the second angle sensor; a transmission rod drives at the bottom of the groove; a bulge is formed on the transmission rod; the bulge is located at the bottom of the strip-shaped groove; a cylindrical shaft is formed on the bulge; a roller is arranged on the cylindrical shaft in a sleeving manner; a strip-shaped groove is further formed in the position, corresponding to the strip-shaped groove, on the lower surface of the pull rod; an outward gap is formed in one side, facing the reset rod, in the strip-shaped groove of the pull rod; the roller rolls in the strip-shaped groove of the pull rod, and is separated from the pull rod at the gap;

in the first side lower locking structure, a transmission strip is connected to a lower locking block; a lower lock cylinder is arranged at an edge position on the lower locking block; an inward tilting spring bolt extends from the lower side of the lower lock cylinder; a lower lock seat is mounted at the position, corresponding to the locking position of the lower locking block, on the frame;

a lower side built-in transfer hinge is mounted at the lower corner of the junction of the frame and the sash; a hinge support is mounted on the frame and is mounted in a manner of matching a second hinge seat.

Preferably, a locking bulge is formed on an upper lock point; the overall structure of the lower lock seat is L-shaped; the upper end of the lower lock seat is connected to the locking bulge; an inclined surface for connecting two sides is formed at a corner, and a clamping bar is formed on one side of a vertical wall; rollers are respectively arranged on the lower lock cylinder and the upper lock cylinder in a sleeving manner; lock sliding block mounting grooves are respectively formed in the edges of the lower surfaces of the upper locking block and the lower locking block, and are used for mounting sliding blocks made of a nylon material.

Preferably, an anti-falling block is mounted on the lower side of the sash; the structure of the anti-falling block includes: a base; the base is mounted on a sash profile; a mounting seat is protruded from the sash profile; a pulley is mounted on the mounting seat; a wind brace is further mounted between the hinge support and the sash.

Preferably, in a mounting end of the first angle sensor, a mounting position at one end includes two T-shaped mounting walls, and a mounting position at the other end includes two step-shaped mounting walls; a mounting position at one end of the second angle sensor includes an I-shaped mounting wall; a mounting position at the other end of the second angle sensor includes a protruded transverse l-shaped mounting wall.

A mounted method for a hardware hinge in the side hung door-window mounted with the built-in transfer hinge includes:

when a first angle sensor is mounted, inserting the first angle sensor into a longitudinal sash profile from an upper side to mount a T-shaped mounting wall between a fifth T-shaped wall and a seventh L-shaped wall; making step-shaped mounting walls sit between the fifth T-shaped wall and the seventh L-shaped wall of a transverse sash profile, and inserting the step-shaped mounting walls between the transverse sash profile and the first angle sensor through a dual-plug, so as to fix the first angle sensor to the sash profile, thereby completing the mounting of the first angle sensor;

when a second angle sensor is mounted, inserting the second angle sensor into a transverse sash profile from a side surface to mount a transverse l-shaped mounting wall between a fifth T-shaped wall and a seventh L-shaped wall; making an I-shaped mounting wall sit between the fifth T-shaped wall and the seventh L-shaped wall of a longitudinal sash profile, and then inserting the I-shaped mounting wall between the longitudinal sash profile and the second angle sensor through a door-shaped dual-plug, so as to fix the second angle sensor to the sash profile, thereby completing the mounting of the second angle sensor;

when a lower lock seat is mounted, hooking a clamping bar into a second T-shaped wall of the longitudinal profile, then making the other side of the lower lock seat sit into a second L-shaped wall, and making the lower end fall into a second T-shaped wall and a second L-shaped wall of a transverse frame profile, penetrating an embedding strip for fixing, thereby completing the mounting of the lower lock seat,

where a mounting method for a hinge seat of an upper side built-in transfer hinge, and a mounting method for a hinge block of a lower side built-in transfer hinge, and a mounting method for a first hinge seat and a hinge block of a side hung door-window are the same.

Preferably, the horizontal pivoting window with the built-in transfer hinge includes a mullion connecting piece and a horizontal push type pressing line clamping seat structure. The mounting manner of the horizontal pivoting window with the built-in transfer hinge is the same as that of the side hung window with the built-in transfer hinge.

The present disclosure has the following beneficial effects:

(1) In the structures of the frame profile and the sash profile of the present disclosure, the fifth L-shaped wall of the frame profile is combined with the hook-shaped wall of the sash profile; when the door-window is closed, the lap area is increased, and the sealing performance is better; after the sash is opened, the sash profile is connected to the frame profile by the hook-shaped wall in the sash profile, so that attractiveness is greatly improved. The connecting structures for the built-in transfer hinge and the frame profile and for the built-in transfer hinge and the frame profile in the present disclosure are realized by matching embedding structures and respective own structures without using screws, so the problem about maintenance caused by loosening and falling in the use of screws is completely solved, and the problem that the service life of the profiles is shortened because the profile strength is reduced due to screw holes is solved; positioning bar structures are respectively arranged in the hinge seat and the hinge block, so the up-down position of the hinge is fixed, and a displacement situation is avoided; when the built-in transfer hinge of the present disclosure is mounted on the frame profile and the sash profile, the integrity of the sealing rubber strip is ensured; in addition, a mounting position of the built-in transfer hinge of the present disclosure is hidden mounting, which facilitates the operation of subsequent processes; the built-in transfer hinge is in a profile wrapped state when the door-window is closed, so the heat insulating effect of the door-window is improved; the structural design of the built-in transfer hinge of the present disclosure is commonly used in inward opening and outward opening, so the application range of the built-in transfer hinge is expanded, and the opening and closing states of the door-window are increased; the sash is opened by an external force, so that the hinge block rotates around a second pin hole; during a rotating process, the “movement” is realized through the cooperation of the two-link rod, the three-link rod, the clutch rod, and the hinge body, thereby realizing the opening and closing of the sash.

(2) In the hardware structure of the present disclosure, structural parts are mounted firmly by using clamping bars or embedding, which avoids future maintenance and reduces the maintenance cost; rollers are respectively mounted on the upper lock cylinder and the lower lock cylinder, so the operation is smooth and wear-free when the upper lock cylinder and the lower lock cylinder are clamped with lock points; the lock cylinders are mounted at the edge of the locking block, so the lap amount between the frame and the sash is increased after the window sash is locked, thereby increasing the sealing performance of the window; the protrusion amount is also increased to improve the attractiveness of the window sash; a chamfer is formed on the surface of the profile, so the window sash is more attractive; the second hinge seat and the hinge support adopt a pin shaft and pin hole matched manner, so the bearing capacity is good; when the window is tilted inward, the effect of operating conveniently and smoothly without wear is achieved, and meanwhile, the service life of the window is prolonged; the other end of the hinge support is fixed to one end of a wind brace, which effectively prevents the profile from being damaged due to excessive stress and fully protects the profile in opening and closing processes of the sash; the anti-falling block is mounted at a corner of the sash, and the mounting and using of the anti-falling block makes the operation of closing and opening the sash smoothly, so the product quality is improved, and the service life of the sash is prolonged; when the sash is in an inward tilting state, a pull rod pin is limited at a pull rod extension position to keep the inward tilting state stable by a limiting spring mounted at the second angle sensor; when the sash is switched from the inward tilting state to a horizontal opening or locked state, a reset rod assists a pull rod in resetting and ensures a resetting process and a fixing position stable; meanwhile, stable and smooth operation during switching between the inward tilting state and a non-inward tilting state under the action of the limiting spring and the reset rod; the handle is prevented from misoperation to cause the disorder of a transmission system in an inward tilting state or an opening state by matching the safety shifting fork and the safety groove; both the first angle sensor and the second angle are of integrally formed structures, so that the mounting accuracy is improved, and the attractiveness of the profiles after being mounted is improved, thereby improving the market competitiveness.

(3) When the second profile is connected to the first profile, in the prior art, the end surface of the second profile is milled into a port in the same shape as the appearance of the first profile. But in process, not completely the same, but similar, shapes are milled, and the error is big, so the junction between the first profile and the second profile is large in crack, poor in sealing property, and low in connecting strength. However, in the present disclosure, because there are the first convex wall and the mounting groove structure in the two-body connecting piece, the mounting groove is clamped into the second L-shaped wall and the transverse wall of the second T-shaped wall, and the forming heights of the first convex wall and the longitudinal wall of the second L-shaped wall are the same, so that the end part of the second profile is in contact with the first convex wall to form flat connection when the second profile is in contact with the first profile, thereby controlling the crack within a minimal range; in the clamping bar connecting piece, after the clamping groove is fixed to the fifth L-shaped wall and the third T-shaped wall, the convex wall is matched with a space formed by a second convex wall structure and the transverse wall of the fifth L-shaped wall; the forming heights of the pedestal and the longitudinal wall of the third L-shaped wall are the same, so when the second profile is in contact with the first profile, the end part may form flat connection with the pedestal, the convex wall, and the second convex wall, thereby controlling the crack within the minimal range; when a profile is cut, the end surface of the second profile is cut into a plane, and then the fifth L-shaped wall of the second profile is cut to remove the length of the longitudinal wall of the fifth L-shaped wall, so that the second profile is highly matched with the fifth L-shaped wall of the first profile during mounting. The space between the heat insulating cavity of the second profile and the first profile is filled with the sealing rubber strip. The pop-rivet penetrates through the first profile to fix the two-body connecting piece, applies a tensile force to the connecting piece in the transverse direction, resists pressure in the longitudinal direction, and meanwhile strengthens the strength of a connecting part in the transverse direction and the longitudinal direction, which makes the connection more stable and firm in front-back direction; after glue is injected, all diversion glue grooves are full of glue, particularly, when the two-body connecting piece and the clamping bar connecting piece are mounted on the first profile, the contact positions between the two-body connecting piece and the first profile and between the clamping bar connecting piece and the first profile are also sealed by the injected glue, which improves the sealing property of the profile; meanwhile, the connecting position is more firm, and the connecting strength of the second profile and the second profile is strengthened under the binding action of the glue and the fixing action of the pop-rivet and the pin. The attractiveness, the sealing performance, and the connecting strength are greatly improved.

(4) The structure of the pressing line is tubular, is high in strength, and does not deform easily; the pressing line are assembled by an angle combining piece which achieves a supporting effect on the end parts of the pressing line and also achieve a limiting effect, so, after the pressing line is assembled, the surface is flat, there is no height difference, the crack is very small, thereby improving the attractiveness; in addition, during transportation, construction, or other cross operations, the structure of the pressing line is stable, and the quality of the window is ensured; the clamping seat structure of the present disclosure realizes horizontal pushing mounting of the relative positions between the clamping seat and the pressing line when the pressing line is mounted; the mounting and detaching manners are very simple; a large amount of manpower and time are saved; when the clamping seat is mounted on the profile, an elastic hook achieves an effect on fixing the clamping seat to the profile, and there is no relative moving space, so the clamping seat is more firm and stable, and does not fall easily in this fixing manner. After the pressing line is mounted, the inward folded hook in the Z-shaped body hooks the pressing line hook bar to achieve a clamping effect, so the pressing line is mounted stably and firmly.

### BRIEF DESCRIPTION OF THE DRAWINGS

FIG. 1 is a schematic structural diagram of a cross section of a built-in transfer hinge;

FIG. 2 is a schematic diagram of a mounting structure of a frame profile and the built-in transfer hinge of the present disclosure;

FIG. 3 is a schematic structural diagram of the built-in transfer hinge of the present disclosure;

FIG. 4 is a schematic structural diagram of the built-in transfer hinge of the present disclosure;

FIG. 5 is a schematic structural diagram of the built-in transfer hinge of the present disclosure;

FIG. 6 is a schematic diagram of a mounting structure of the built-in transfer hinge, an embedding strip, and a T-shaped embedding block of the present disclosure;

FIG. 7 is a schematic diagram of a mounting structure of the built-in transfer hinge, the embedding strip, and the T-shaped embedding block of the present disclosure;

FIG. 8 is a schematic diagram of a partial structure of the built-in transfer hinge of the present disclosure;

FIG. 9 is a schematic structural diagram of a first hinge seat of the present disclosure;

FIG. 10 is a schematic structural diagram of the first hinge seat of the present disclosure;

FIG. 11 is a schematic structural diagram of the first hinge seat of the present disclosure;

FIG. 12 is a schematic structural diagram of a hinge block of the present disclosure;

FIG. 13 is a schematic structural diagram of the hinge block of the present disclosure;

FIG. 14 is a schematic structural diagram of the hinge block of the present disclosure;

FIG. 15 is a schematic structural diagram of a hinge body of the present disclosure;

FIG. 16 is a schematic structural diagram of the hinge body of the present disclosure;

FIG. 17 is a schematic structural diagram of an embedding strip of the present disclosure;

FIG. 18 is a schematic structural diagram of the embedding strip of the present disclosure;

FIG. 19 is a schematic structural diagram of a window mounted with the built-in transfer hinge of the present disclosure;

FIG. 20 is a schematic diagram of a mounting structure at an upper lock point of A in FIG. 19;

FIG. 21 is a schematic diagram of an upper locking structure of C in FIG. 19;

FIG. 22 is a schematic diagram of a mounting structure at a T-shaped mounting wall of a first angle sensor;

FIG. 23 is an enlarged view of a structure in a circle of FIG. 22;

FIG. 24 is a schematic diagram of a mounting structure at a step-shaped mounting wall of the first angle sensor;

FIG. 25 is an enlarged view of a structure in a circle of FIG. 24;

FIG. 26 is a schematic diagram of an upper locking structure of the present disclosure;

FIG. 27 is a schematic structural diagram at a second angle sensor of the present disclosure;

FIG. 28 is a schematic structural diagram of a pull rod of the present disclosure;

FIG. 29 is a schematic structural diagram of the second angle sensor of the present disclosure;

FIG. 30 is a schematic structural diagram of an I-shaped mounting wall without a mounting structure of the second angle sensor of the present disclosure;

FIG. 31 is an enlarged view of a structure in a circle of FIG. 30;

FIG. 32 is a schematic structural diagram of an upper hinge of the present disclosure;

FIG. 33 is a schematic structural diagram of a limiting spring of the present disclosure;

FIG. 34 is a schematic diagram of a lower locking structure at D in FIG. 19;

FIG. 35 is a schematic structural diagram of a lower lock seat at B in FIG. 19;

FIG. 36 is a mounting schematic diagram at a lower hinge of the present disclosure;

FIG. 37 is a schematic structural diagram of E in FIG. 36;

FIG. 38 is a schematic structural diagram of a hinge support of the present disclosure;

FIG. 39 is a schematic structural diagram of a second hinge seat of the present disclosure;

FIG. 40 is a mounting schematic diagram of the hinge support and the second hinge seat of the present disclosure;

FIG. 41 is a schematic structural diagram of a sash profile of the present disclosure;

FIG. 42 is a schematic structural diagram of a frame profile of the present disclosure;

FIG. 43a is a schematic structural diagram of a dual-plug of the present disclosure;

FIG. 43b is a schematic structural diagram of a door-shaped dual-plug of the present disclosure;

FIG. 44 is a schematic structural diagram of a two-body connecting piece of the present disclosure;

FIG. 45 is a schematic structural diagram of the two-body connecting piece of the present disclosure;

FIG. 46 is a perspective schematic structural diagram of one part of the two-body connecting piece of the present disclosure;

FIG. 47 is a perspective schematic structural diagram of one part of the two-body connecting piece of the present disclosure;

FIG. 48 is a main view of one part of the two-body connecting piece of the present disclosure;

FIG. 49 is a rear view of one part of the two-body connecting piece of the present disclosure;

FIG. 50 is a schematic structural diagram of a clamping bar connecting piece of the present disclosure;

FIG. 51 is a schematic structural diagram of a second base body of the clamping bar connecting piece of the present disclosure;

FIG. 52 is a schematic structural diagram of the second base body of the clamping bar connecting piece of the present disclosure;

FIG. 53 is a main view of the second base body of the clamping bar connecting piece of the present disclosure;

FIG. 54 is a rear view of the second base body of the clamping bar connecting piece of the present disclosure;

FIG. 55 is a schematic structural diagram of a pedestal of the clamping bar connecting piece of the present disclosure;

FIG. 56 is a schematic structural diagram of the pedestal of the clamping bar connecting piece of the present disclosure;

FIG. 57 is a main view of a single-head pop-rivet of the present disclosure;

FIG. 58 is a side view of a double-head pop-rivet of the present disclosure;

FIG. 59 is a stereogram of a single-head pop-rivet of the present disclosure;

FIG. 60 is a stereogram of a single-head pop-rivet of the present disclosure;

FIG. 61 is a schematic diagram of a mounting plane of a mullion connecting piece and a profile of the present disclosure;

FIG. 62 is a schematic diagram of a connecting structure of the two-body connecting piece and the profile of the present disclosure;

FIG. 63 is a schematic diagram of a mounting structure of the mullion connecting piece and the profile of the present disclosure;

FIG. 64 is a schematic diagram of a mounting structure of the mullion connecting piece and the profile of the present disclosure;

FIG. 65 is a schematic structural diagram of a clamping seat of the present disclosure;

FIG. 66 is a schematic structural diagram of the clamping seat of the present disclosure;

FIG. 67 is a schematic diagram of a cross section of the clamping seat of the present disclosure;

FIG. 68 is a schematic structural diagram of a pressing line of the present disclosure;

FIG. 69a and FIG. 69b are respectively schematic structural diagrams of an angle combining piece of the present disclosure;

FIG. 70 is a schematic diagram of a mounting structure of the pressing line and the angle combining piece of the present disclosure;

FIG. 71 is a schematic diagram of an assembling structure of the pressing line of the present disclosure;

FIG. 72 is a schematic diagram of a mounting structure of a holding seat and the profile of the present disclosure;

FIG. 73 is a mounting plane diagram of the holding seat, the pressing line, and the profile of the present disclosure;

FIG. 74 is a schematic diagram of the mounting structure of the holding seat, the pressing line, and the profile of the present disclosure;

FIG. 75 is a schematic diagram of the mounting structure of the holding seat, the pressing line, and the profile of the present disclosure;

FIG. 76 is a schematic diagram of the mounting structure of the holding seat, the pressing line, and the profile of the present disclosure.

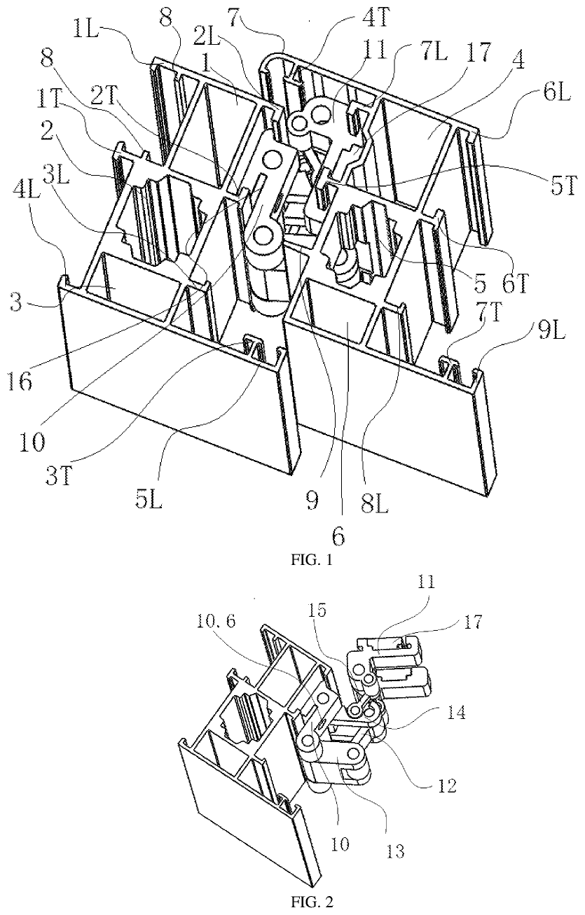

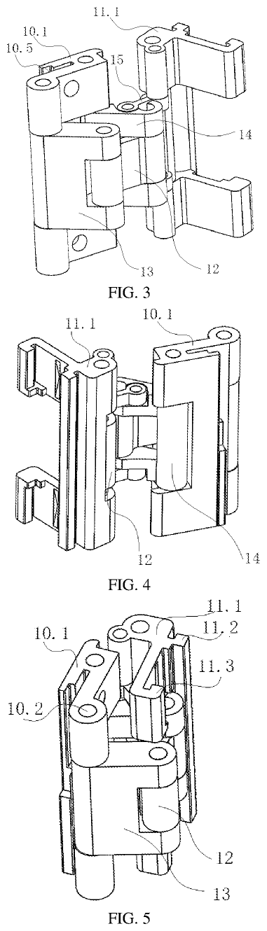

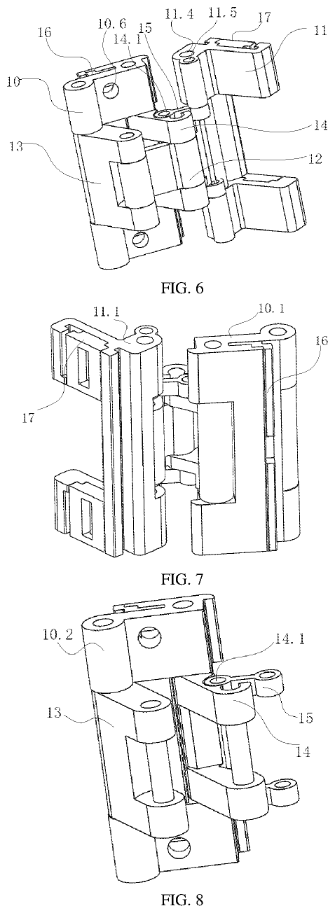

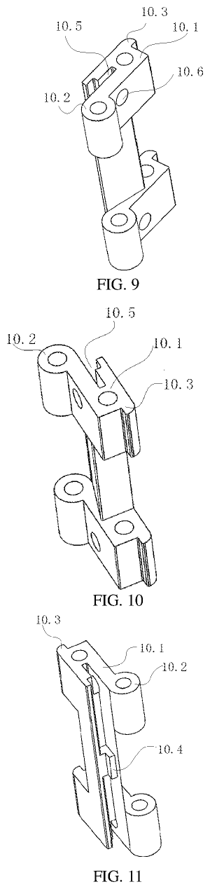

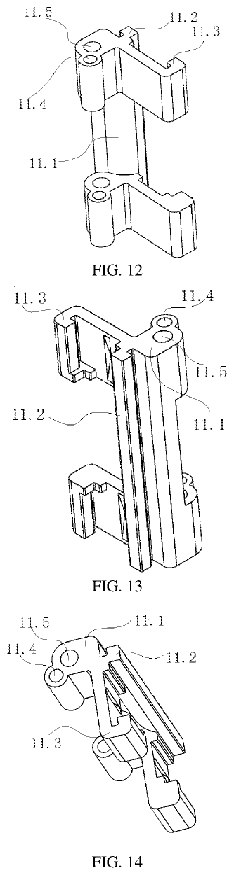

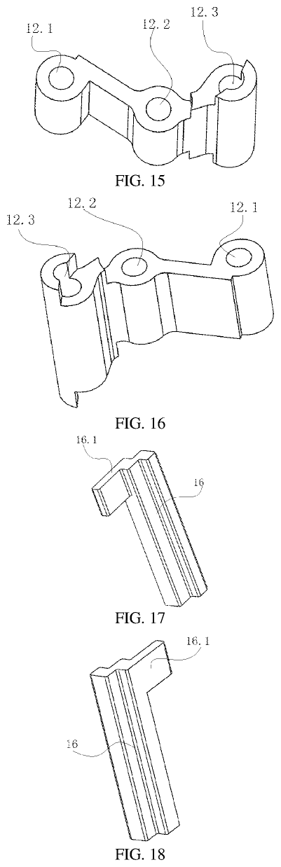

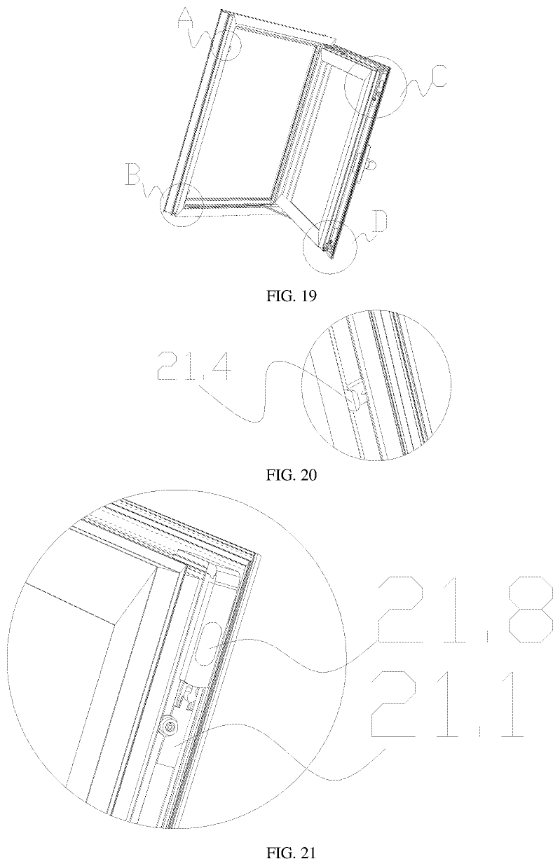

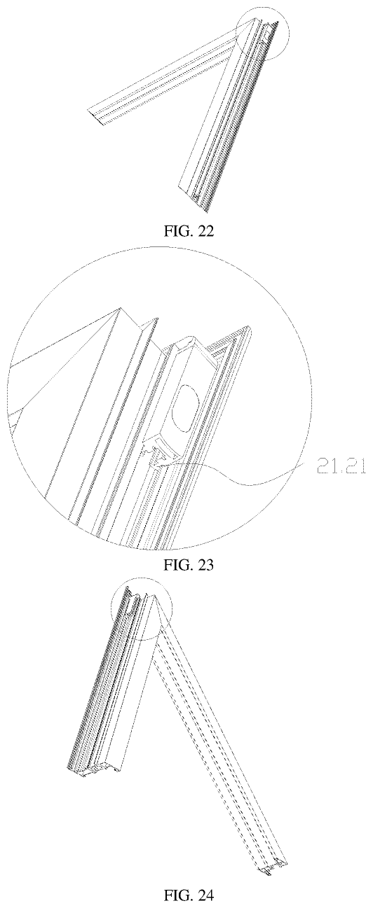

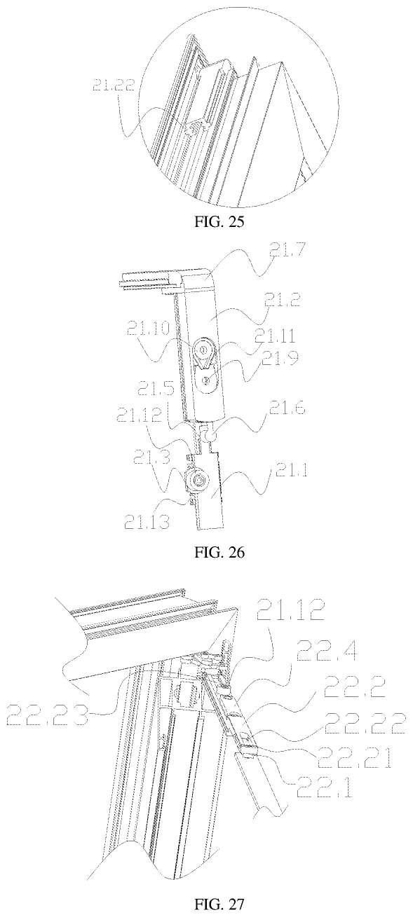

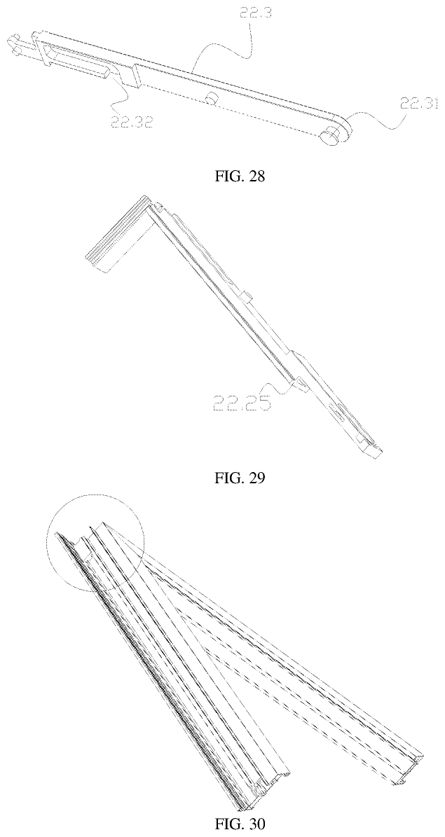

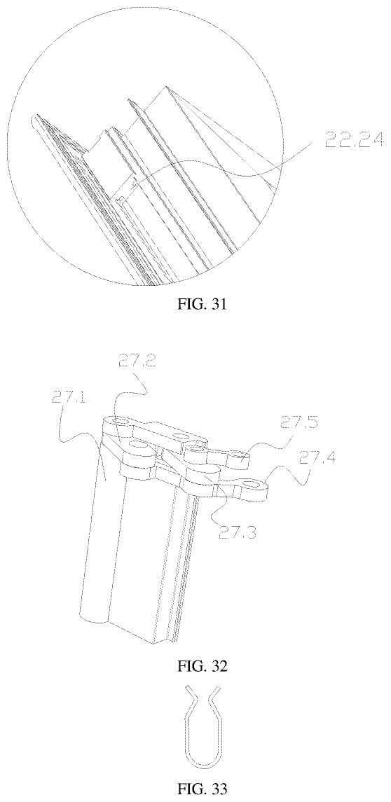

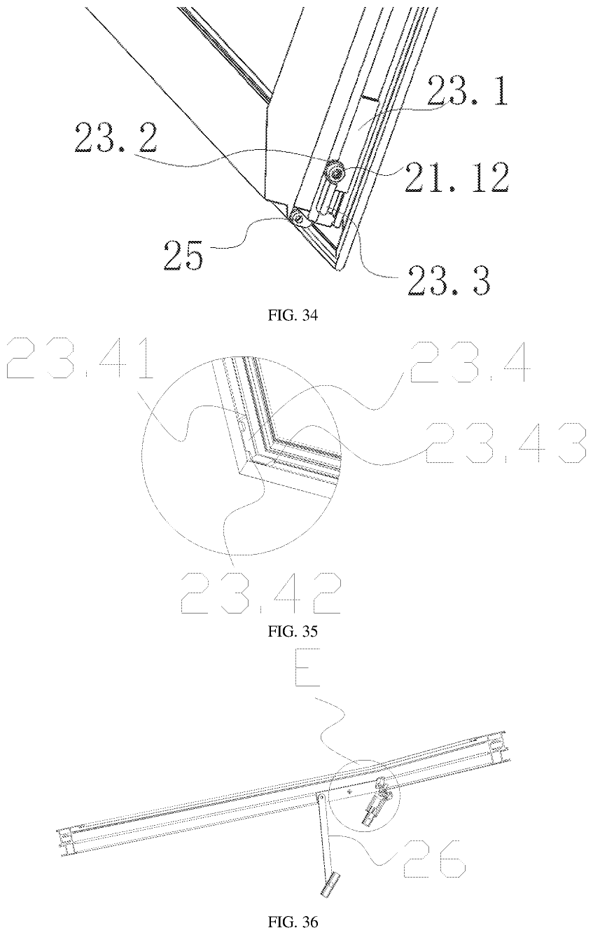

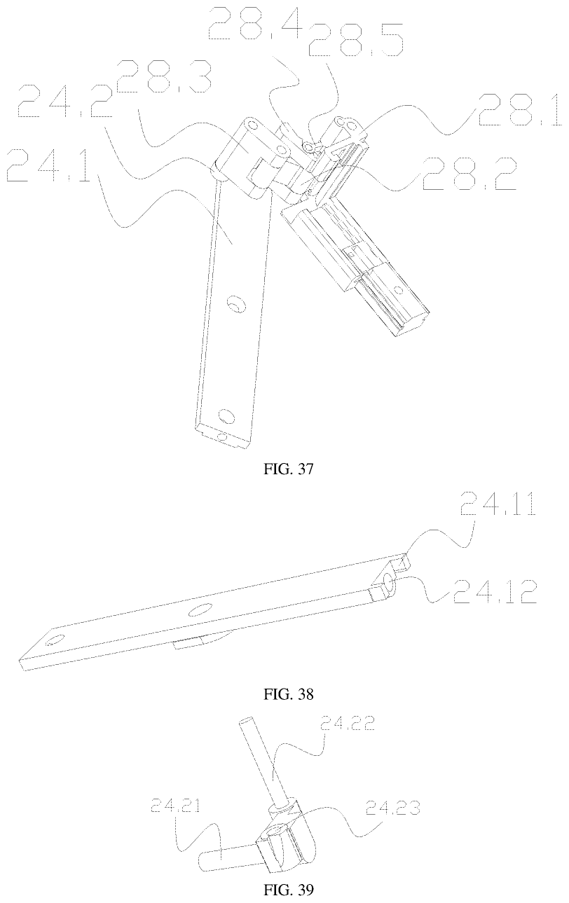

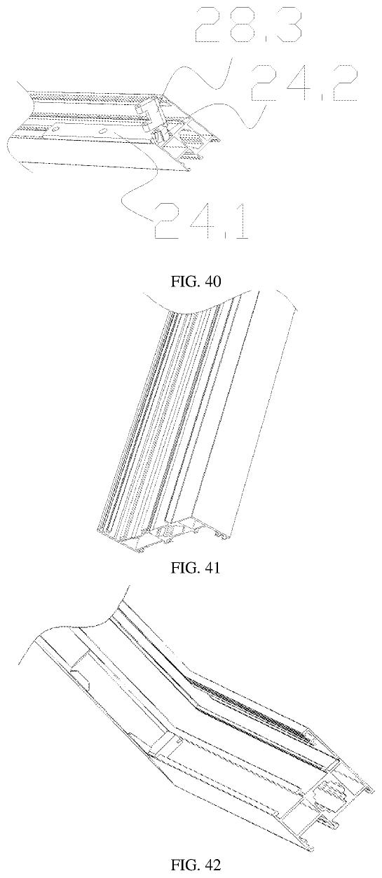

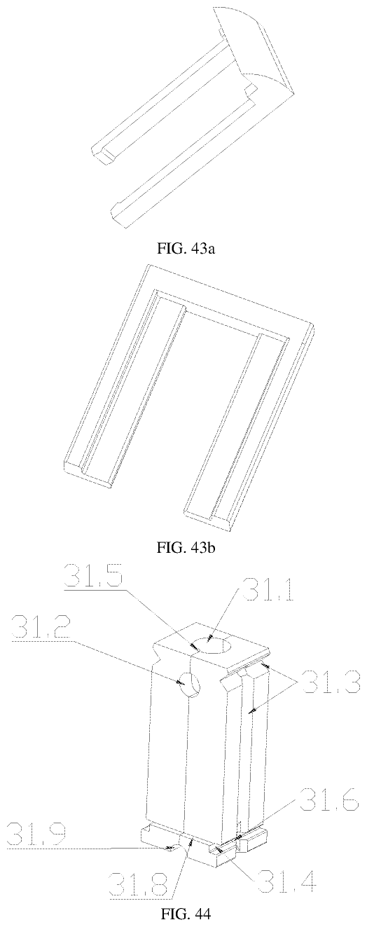

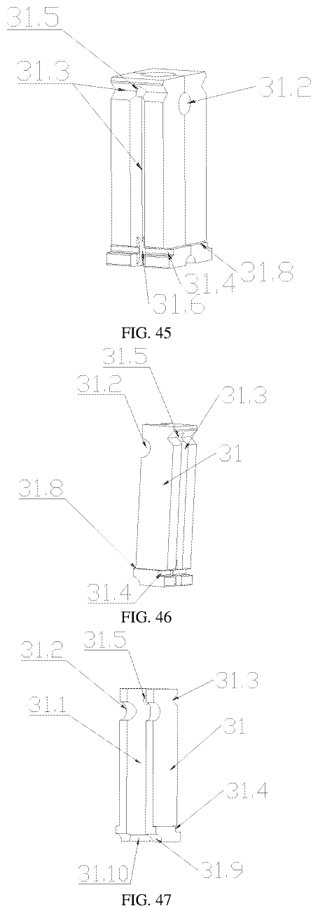

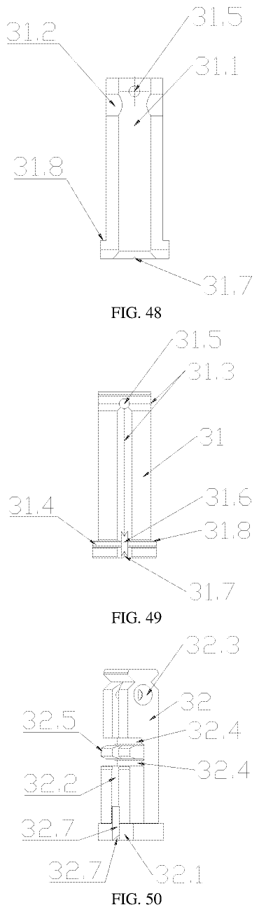

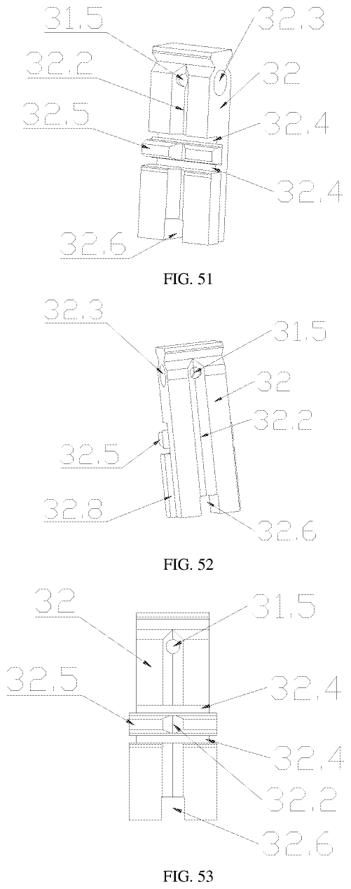

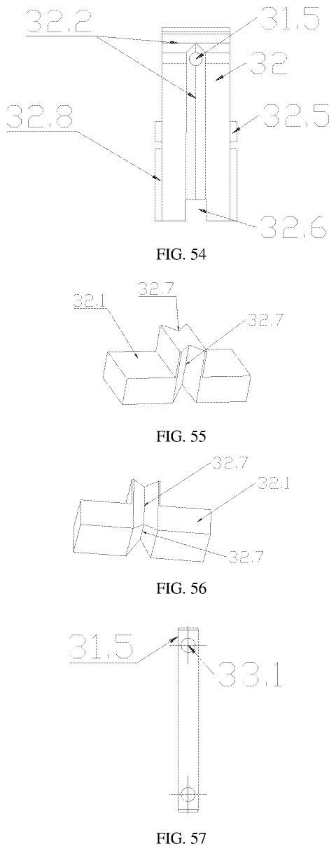

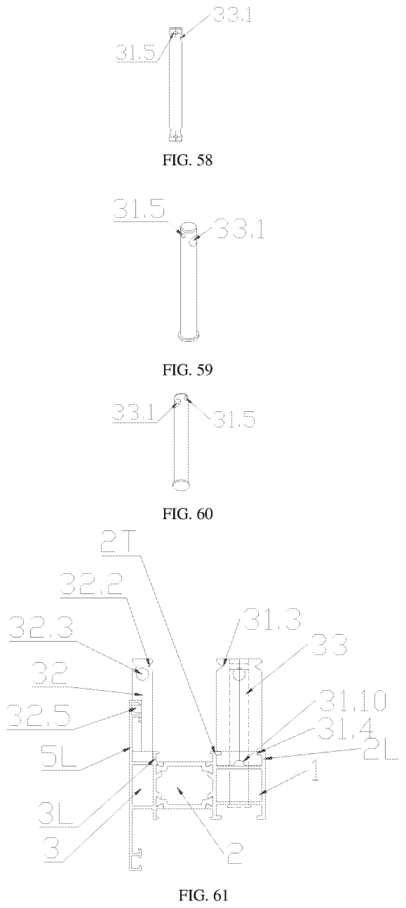

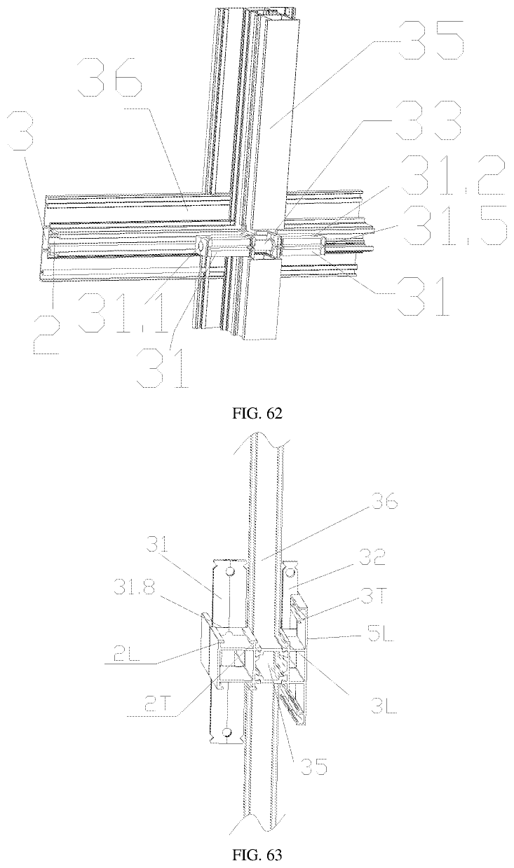

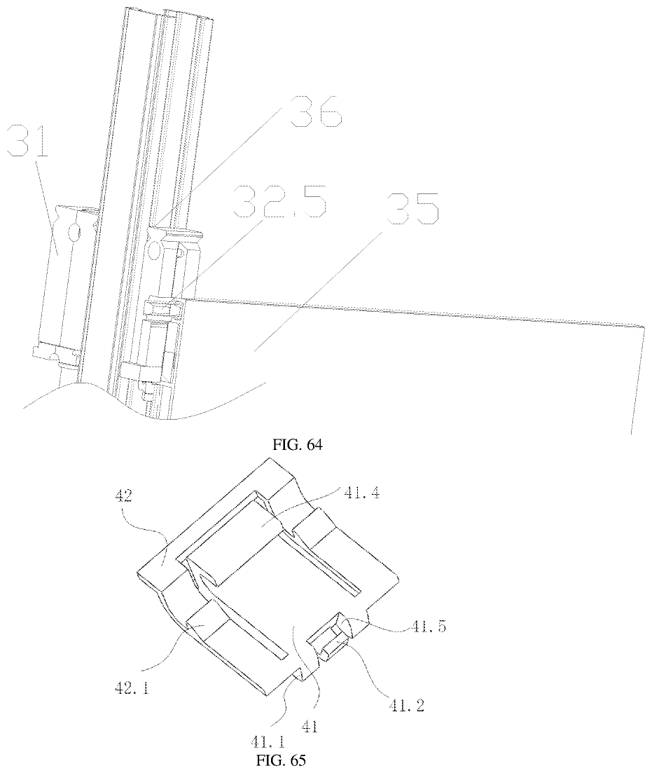

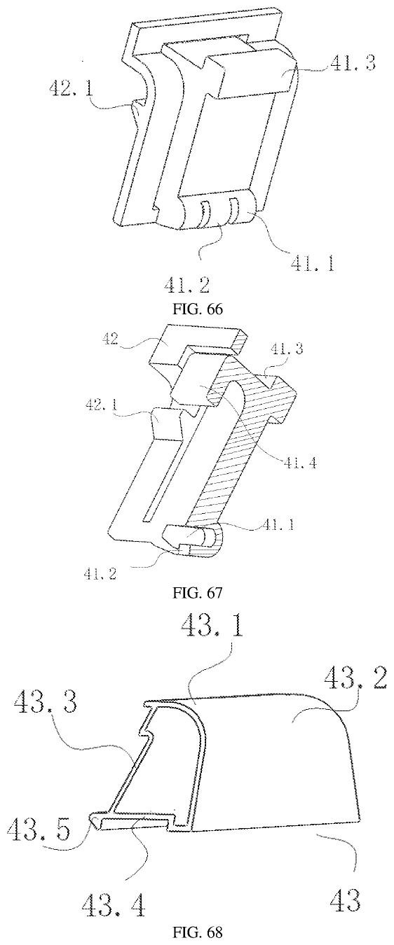

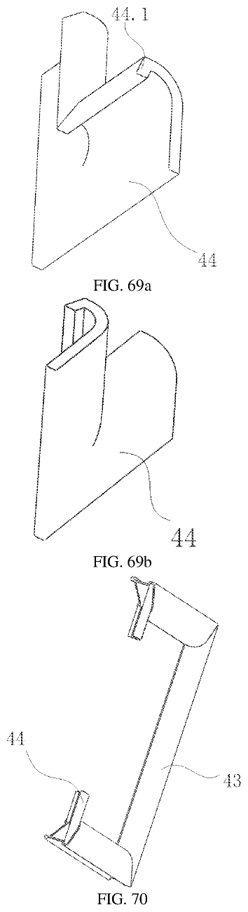

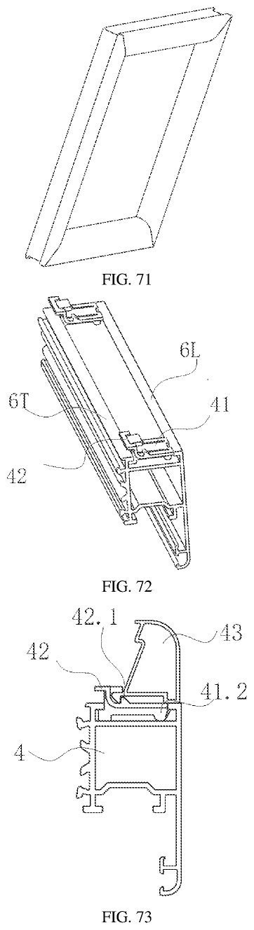

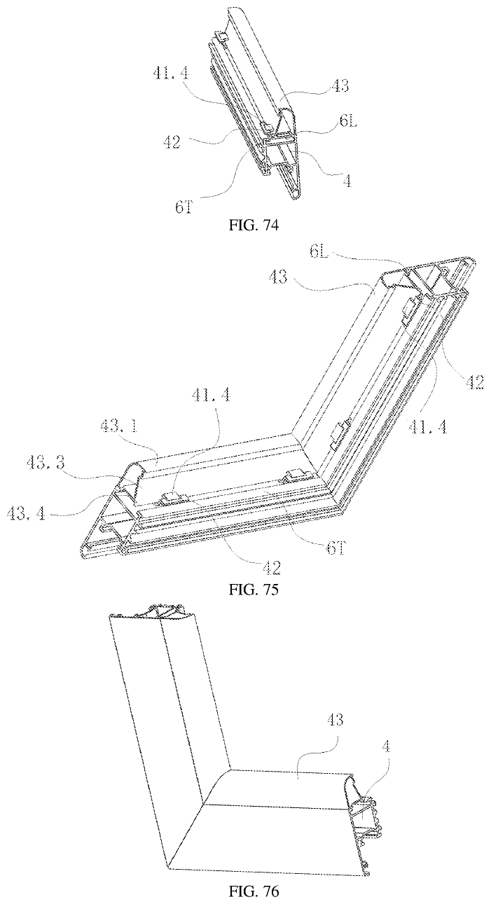

In the drawings: 1—first cavity, 2—first heat insulating cavity, 3—second cavity, 4—third cavity, 5—second heat insulating cavity, 6—fourth cavity, 7—hook-shaped wall, 8—convex wall, 9—sealing bar, 10—hinge seat, 10.1—first base body, 10.2—cylindrical body, 10.3—arc-shaped hook bar, 10.4—positioning bar, 10.5—embedding mounting groove, 10.6—detaching working hole, 11—hinge block, 11.1—second base body, 11.2—mounting bar, 11.3—hook-shaped mounting bar, 11.4—first pin hole, 11.5—second pin hole, 12—hinge body, 12.1—two-link rod connecting pin hole, 12.2—three-link rod connecting pin hole, 12.3—hinge block connecting pin hole, 13—two-link rod, 14—three-link rod, 14.1—clutch rod connecting pin hole, 15—clutch rod, 16—embedding strip, 16.1—detaching wall, 17—T-shaped embedding block, 1L—first L-shaped wall, 2L—second L-shaped wall, 3L—third L-shaped wall, 4L—fourth L-shaped wall, 5L—fifth L-shaped wall, 6L—sixth L-shaped block, 7L—seventh L-shaped wall, 8L—eighth L-shaped wall, 1T—first T-shaped wall, 2T—second T-shaped wall, 3T—third T-shaped wall, 4T—fourth T-shaped wall, 5T—fifth T-shaped wall, 6T—sixth T-shaped block, 7T—seventh T-shaped wall, 21.1—upper locking block, 21.2—first angle sensor, 21.21—T-shaped mounting wall, 21.22—step-shaped mounting wall, 21.3—upper lock cylinder, 21.4—upper lock point, 21.5—safety groove, 21.6—safety shifting fork, 21.7—dual-plug, 21.8—buckle cover, 21.9—convex shaft, 21.10—cylindrical bulge, 21.11—spring, 21.12—roller, 21.13—sliding block mounting groove, 22.1—transmission rod, 22.2—second angle sensor, 22.21—arc-shaped notch, 22.22—waist-shaped groove, 22.23—strip-shaped groove, 22.24—I-shaped mounting wall, 22.25—transverse l-shaped mounting wall, 22.3—pull rod, 22.31—pull rod pin, 22.32—gap, 22.4—reset rod, 23.1—lower locking block, 23.2—lower lock cylinder, 23.3—inward tilting spring bolt, 23.4—lower lock seat, 23.41—inclined surface, 23.42—clamping bar, 24.1—hinge support, 24.11—groove, 24.12—pin shaft hole, 24.2—second hinge seat, 24.21—first convex shaft, 24.22—second convex shaft, 24.23—pin hole, 25—anti-falling block, 26—wind brace, 27.1—upper hinge seat (which has the same structure as the first hinge seat, and the difference only in the specific positions of the groove and a truncation position), 27.2—upper two-link rod, 27.3—upper three-link rod, 27.1—upper hinge seat, 27.5—upper clutch rod, 28.1—lower hinge block, 28.2—lower hinge body, 28.3—lower two-link rod, 28.4—lower three-link rod, 28.5—lower clutch rod, 31—first base body, 31.1—pop-rivet half-hole, 31.2—pin half-hole, 31.3—first T-shaped diversion glue groove, 31.4—mounting groove, 31.5—diversion glue hole, 31.6—diversion groove, 31.7—second diversion glue groove, 31.8—first convex wall, 31.9—arc-shaped gap, 31.10—chamfer, 32—second base body, 32.1—pedestal, 32.2—second T-shaped diversion glue groove, 32.3—fixing hole, 32.4—clamping groove, 32.5—fixing clamping bar, 32.6—slot, 32.7—third diversion glue groove, 32.8—second convex wall, 33—pop rivet, 33.1—hole, 35—first profile, 36—second profile, 41—base, 41.1—holding foot, 41.2—elastic hook, 41.3—outward folded hook, 41.4—inward folded hook, 41.5—concave gap, 42—elastic hook body, 42.1—hook bar, 43—pressing line, 43.1—external corner, 43.2—outer surface, 43.3—back surface, 43.4—bottom surface, 43.5—pressing line hook bar, 44—angle combining piece, and 44.1—support wall.

### DETAILED DESCRIPTION

The following describes structures of a side hung door-window and a horizontal pivoting window of the present disclosure through specific embodiments, and is interspersed with a built-in transfer hinge.

### Embodiment 1

Referring to the accompanying drawings, a side hung door-window with a built-in transfer hinge includes a frame and a sash. The frame is connected to the sash through the built-in transfer hinge.

In the frame, the structure of the frame profile includes: a first cavity 1, a first heat insulating cavity 2, and a second cavity 3. A first L-shaped wall 1L and a second L-shaped wall 2L respectively extend from two sides of an outer side wall of the first cavity 1. A first T-shaped wall 1T and a second T-shaped wall 2T respectively extend from two sides of a wall between the first cavity 1 and the first heat insulating cavity 2. A third L-shaped wall 3L extends from a wall between the first heat insulating cavity 2 and the second cavity 3. A fourth L-shaped wall 4L and a fifth L-shaped wall 5L extend from an outer side wall of the second cavity 3. A third T-shaped wall 3T is arranged on the fifth L-shaped wall; first convex walls 8 are further respectively arranged on the opposite positions of the first L-shaped wall and the first T-shaped wall.

In the sash, the structure of the sash profile includes: a third cavity 4, a second heat insulating cavity 5, and a fourth cavity 6. A sixth L-shaped wall 6L extends from one of two sides of an outer side wall of the third cavity 4, and a hook-shaped wall 7 extends from the other side of the two sides of the outer side wall of the third cavity 4. A fourth T-shaped wall 4T is arranged on the hook-shaped wall 7. A fifth T-shaped wall 5T and a sixth T-shaped wall 6T respectively extend from a wall between the third cavity 4 and the second heat insulating cavity 5. A seventh L-shaped wall 7L is arranged close to the hook-shaped wall 7 between the fifth T-shaped wall 5T and the hook-shaped wall 7. The inner wall surface of the third cavity between the fifth T-shaped wall 5T and the hook-shaped wall 7 forms a concave groove towards the cavity. An eighth L-shaped wall 8L is formed on the wall between the second heat insulating cavity 5 and the fourth cavity 6. The outer side wall of the fourth cavity 6 extends to form a ninth L-shaped wall 9L. A seventh T-shaped wall 7T is formed on the ninth L-shaped wall 9L. The second heat insulating cavity is externally connected to a first sealing bar 9. A sealing rubber strip is mounted between the hook-shaped wall 7 and the fourth T-shaped wall 4T. When the door-window is closed, the sealing performance of the door-window is enhanced; meanwhile, when the sash is opened, the sealing rubber strip is connected to the frame profile, which improves the attractiveness.

The structure of the built-in transfer hinge includes a first hinge seat 10, a hinge block 11, and a hinge body 12. The first hinge seat 10 is connected to a frame. The hinge block 11 is connected to a sash. The hinge body 12 is connected to the first hinge seat 10 through a two-link rod 13 and a three-link rod 14. The hinge block 11 is connected to the hinge body 12, and a clutch rod 15 is further connected between the hinge block 11 and the three-link rod 14.

The first hinge seat 10 is that a first base body 10.1 is connected to a cylindrical body 10.2. An arc-shaped hook bar 10.3 is arranged at one end part of two end parts of one side surface of the first base body 10.1, and an embedding mounting groove 10.5 is formed in the other end part of the two end parts of one side surface of the first base body 10.1. The arc-shaped hook bar 10.3 is connected to the second L-shaped wall 2L. An embedding strip 16 is mounted in the embedding mounting groove 10.5 and is fixed to the second T-shaped wall 2T. A positioning bar 10.4 is protruded from the first base body 10.1 at the position in contact with the second L-shaped wall 2L. The length of the positioning bar 10.4 is less than that of the first base body 10.1.

The embedding strip 16 includes a first transverse wall connected to a longitudinal wall and then connected to a second transverse wall. The second transverse wall is connected to a detaching wall 16.1. The length of the detaching wall 16.1 is less than that of the overall embedding strip 16. A detaching working hole 10.6 is further formed in the first base body 10.1. After the embedding strip is mounted, the detaching wall is located at a slightly upper part of the detaching working hole.

A groove is formed in the transverse middle part of the first base body 10.1. Through pin holes are formed in upper walls and lower walls of two ends of the groove. The cylindrical body 10.2 is truncated at the middle, and through pin holes are respectively formed in an upper part and a lower part. The length of the groove in the first base body 10.1 is equal to that of a truncated part of the cylindrical body, and the part is a mounting connecting part. In the mounting connecting part, the surface is ascended aslant in the direction from the cylindrical body 10.2 to the first base body 10.1.

The hinge block includes a second base body 11.1. Two ends of one side of the second base body 11.1 respectively form into arcs which are mounted between the fourth T-shaped wall 4T and the seventh L-shaped wall 7L. On the other side, one end part is connected to a mounting bar 11.2 and a hook-shaped mounting bar 11.3. The mounting bar 11.2 is mounted inside a transverse section of the seventh L-shaped wall 7L. The hook-shaped mounting bar 11.3 is mounted at the fifth T-shaped wall 5T. A protruded part is formed at the other end part, and a first pin hole 11.4 is formed in the protruded part. A second pin hole 11.5 is formed in the position, close to the first pin hole 11.4, of the second base body 11.1. The centers are cut away at the positions of the first pin hole 11.4 and the second pin hole 11.5. Cutting positions are also formed in the hook-shaped mounting bar 11.3 and the fifth T-shaped wall 5T. Solid walls with the same structures as that of the fifth T-shaped wall 5T are formed in the hook-shaped parts at the two ends of a cutting position formed on the hook-shaped mounting bar 11.3, and the solid walls are limiting fixing structures. The hinge block is fixed by a T-shaped embedding block 17 within the space formed by the hook-shaped mounting bar 11.3 and a wall of the fourth cavity 6.

The hinge body 12 includes a body. A two-link rod connecting pin hole 12.1, a three-link rod connecting pin hole 12.2, and a hinge block connecting pin hole 12.3 are formed in the body. A forming part of the two-link rod connecting pin hole 12.1 is cylindrical, and is integrally formed with the body. The three-link rod connecting pin hole 12.2 is located in the middle position of the body, and the two sides of the hinge body are at a bending angle bounded by the three-link rod connecting pin hole 12.2. The length of the forming part of the hinge block connecting pin hole 12.3 is greater than that of the other parts of the body, so as to accommodate the thickness of the clutch rod 15.

The two-link rod 13 and the three-link rod 14 are respectively U-shaped, and pin holes are respectively formed in the transverse walls and the end parts, where a clutch rod connecting pin hole 14.1 is further formed on the inner side of the end part of the three-link rod 14. A pin is mounted in the pin hole in the transverse wall of the two-link rod 13 and the pin hole in the cylindrical body 10.2 in a matched manner; a pin is mounted in an end part pin hole and the two-link rod connecting pin hole 12.1 in the hinge body 12 in a matched manner; a pin is mounted in the pin hole in the transverse wall of the three-link rod 14 and the pin hole in the first base body 10.1 in a matched manner; a pin is mounted in the end part pin hole and the three-link rod connecting pin hole 12.2 in the hinge body 12. On a sash profile, a position opening is formed in the position, corresponding to the two-link rod 13, in the wall of the second heat insulating cavity, so as to accommodate the end part of the two-link rod 13 when the hinge is folded.

In a cut part of the hinge block 11, a pin is mounted in a first pin hole 11.4 and a pin hole in one end of a clutch rod 15 in a matched manner; a pin is mounted in a pin hole in the other end of the clutch rod 15 and the clutch rod connecting pin hole 14.1 of the three-link rod 14 in a matched manner; a pin is mounted in a second pin hole 11.5 and a hinge body connecting pin hole 12.3 in a matched manner.

### Embodiment 2

A mounting method for the side hung door-window with the built-in transfer hinge in Embodiment 1 includes the following steps:

step 1: movably and fixedly mounting each of the first hinge seat 10, the hinge body 12, the hinge block 11, the two-link rod 13, the three-link rod 14, and the clutch rod 15 by mounting pins in pin holes, so as to complete the assembling the overall hinge;

step 2: forming a notch with the same length as the positioning bar 10.4 in the transverse wall of the second T-shaped wall 2T at the position, corresponding to the positioning bar 10.4, where the first hinge seat 10 is mounted on a frame; firstly, clamping the arc-shaped hook bar 10.3 into a second L-shaped wall 2L, and rotating the first base body 10.1 around the arc-shaped hook bar 10.3 to make the cylindrical body 10.2 abut the second T-shaped wall 2T; simultaneously, mounting the positioning bar 10.4 into the notch, penetrating the embedding strip 16 into the embedding mounting groove 10.5, thereby mounting the first hinge seat 10 on a frame profile;

step 3: at the position where a hinge block 11 is mounted on a sash, clamping the hook-shaped mounting bar 11.3 on a fifth T-shaped wall 5T, and simultaneously, matching the structure of the solid wall with the structure of the fifth T-shaped wall 5T; simultaneously, mounting an arc-shaped end part between the fourth T-shaped wall 4T and the seventh L-shaped wall 7L, and mounting a mounting bar 11.2 on the inner side of a transverse section of the seventh L-shaped wall 7L; penetrating a T-shaped embedding block 17 into a space formed by the hook-shaped mounting bar 11.3 and a wall of the fourth cavity 6 to fix the hinge block 11; clamping the T-shaped embedding block 17 between the fifth T-shaped wall 5T and the mounting bar 11.2 to mount the hinge block 11 on a sash profile, thereby mounting the built-in transfer hinge on the side hung door-window.

### Embodiment 3

According to the side hung door-window with the built-in transfer hinge in the Embodiment 2, when the hinge seat 10 needs to be detached in other situations, a screw is penetrated into the detaching working hole 10.6, and the screw is rotated to act on a detaching wall 16.1 to eject the embedding strip 16 out, thereby detaching the hinge seat 10.

### Embodiment 4

A working method of the built-in transfer hinge in Embodiment 1 includes the following steps:

when a door-window is switched from an opening state to a closed state, applying an external force to a sash to close the sash; during this process, rotating the hinge body 12 around the second pin hole 11.5, meanwhile, pulling the clutch rod 15 by a pin in the first pin hole 11.4, then pulling the three-link rod 14 by the clutch rod 15 to change the positions of the three-link rod 14 and the hinge body 12; meanwhile, driving the two-link rod 13 by the hinge body 12, so that the overall hinge is in a folded state, and the sash is closed;

when the door-window is switched from a closed state to an opening state, applying an external force to a sash to open the sash; during this process, rotating the hinge body 12 around the second pin hole 11.5, meanwhile, pushing the clutch rod 15 by the pin in the first pin hole 11.4, and pushing the three-link rod 14 by the clutch rod 15 to change the positions of the three-link rod 14 and the hinge body 12; meanwhile, driving the two-link rod 13 by the hinge body 12, so that the overall hinge is in an unfolded state, and the sash is open.

### Embodiment 5

A horizontal pivoting window with the built-in transfer hinge includes a handle; a transmission structure is connected from the handle to the interior of the profile of the sash; the transmission structure is that the handle is connected to a gear; the gear is connected to a gear rack; two ends of the gear rack are connected to transmission strips; the upper transmission strip is connected to a first side upper locking structure at an upper corner of the sash; the lower transmission strip is connected to a first side lower locking structure at a lower corner of the sash.

In the first side upper locking structure, the upper transmission strip is connected to an upper locking block through a pin shaft and pin hole matched structure; the other end of the upper locking block 21.1 penetrates into a first angle sensor 21.2, and drives within the first angle sensor 21.2; an upper lock cylinder 21.3 is arranged at an edge position on the upper locking block 21.1, and an upper lock point 21.4 is mounted on a frame corresponding to a locking position of the upper lock cylinder 21.3; a locking bulge is formed at the upper lock point 21.4; an upper locking block 21.1 penetrates into one end in a first angle sensor 21.2; multiple safety grooves 21.5 are formed in an outer surface of the upper locking block 21.1; a safety shifting fork 21.6 further extends out from the first angle sensor 21.2; a bulge is formed at an extension end of the safety shifting fork 21.6 and is matched in the safety groove; a waist-shaped groove is formed in the first angle sensor 21.2 at a mounting position of the safety shifting fork 21.6, and a buckle cover 21.8 is mounted on the waist-shaped groove; a convex shaft 21.9 is formed in the waist-shaped groove; a cylindrical bulge 21.10 is formed close to the convex shaft 21.9, the safety shifting fork 21.6 is mounted on the convex shaft 21.9, and two limiting bulges are further formed on the safety shifting fork 21.6; a spring 21.11 bypasses the cylindrical bulge 21.10; two ends of the spring 21.11 are clamped between the two limiting bulges; in the first angle sensor 21.2, a transmission belt which is connected to an upper locking block 21.1 bypasses the first angle sensor 21.2 and is connected to a transmission strip on the upper side of the sash; the transmission strip is connected to a transmission rod 22.1; the transmission rod drives in the second angle sensor 22.2; in the mounting ends of the first angle sensor, the mounting position at one end includes two T-shaped mounting walls 21.21, and the mounting position at the other end includes two step-shaped mounting walls 21.22.

On a second angle sensor 22.2, a pull rod 22.3 is mounted, and one end of the pull rod 22.3 is assembled and connected to a hinge on the upper side; an arc-shaped notch 22.21 is formed in one side of the upper surface of the second angle sensor 22.2; a waist-shaped groove 22.22 is formed adjacent to the arc-shaped notch 22.21; one end of a limiting spring is mounted in the arc-shaped notch 22.21, and the other end of the limiting spring penetrates into the waist-shaped groove 22.22 and forms elastic limiting; a pull rod pin 22.31 is arranged in the limiting spring in a sleeving manner; the pull rod pin 2.31 is fixedly connected to the pull rod 22.3; the middle position of the upper surface of the second angle sensor 22.2 is connected to a reset rod 22.4; the other end of the reset rod 22.4 is connected to the lower surface of the pull rod 22.3; a strip-shaped groove 22.23 is formed in the other side of the upper surface of the second angle sensor 22.2; a transmission rod 22.1 drives at the bottom of the groove; a bulge is formed on the transmission rod 22.1; the bulge is located at the bottom of the strip-shaped groove 22.23; a cylindrical shaft is formed on the bulge; a roller 21.12 is arranged on the cylindrical shaft in a sleeving manner; a strip-shaped groove is further formed in the position, corresponding to the strip-shaped groove, in the lower surface of the pull rod; an outward gap 22.32 is formed in one side, facing the reset rod, in the strip-shaped groove of the pull rod; the roller 21.12 rolls in the strip-shaped groove of the pull rod, and is separated from the pull rod 22.3 at the gap 22.32; the mounting position at one end of the second angle sensor includes an I-shaped mounting wall 22.24, and the mounting position at the other end of the second angle sensor includes a protruded transverse l-shaped mounting wall 22.25.

The structure of the upper hinge is that: the upper hinge seat 27.1 is mounted on the frame; one end of the upper two-link rod 27.2 and one end of the upper three-link rod 27.3 are separately connected to the upper hinge seat 27.1; the other end of the upper two-link rod 27.2 and one end of the upper three-link rod 27.3 are separately connected to the upper hinge body 27.4; the upper three-link rod 27.3 is connected to an upper clutch rod 27.5; a pull rod 22.3 is mounted between the other end of the upper clutch rod 27.5 and the other end of the upper hinge body 27.4.

In the first side lower locking structure, the transmission strip is connected to the lower locking block 23.1. A lower lock cylinder 23.2 is arranged at an edge position on the lower locking block 23.1. An inward tilting spring bolt 23.3 extends from the lower side of the lower lock cylinder 23.2. A lower lock seat 23.4 is mounted on the frame corresponding to the locking position of the lower locking block 23.1. The overall structure of the lower lock seat is L-shaped. The upper end of the lower lock seat is connected to a locking bulge. An inclined surface 23.41 for connecting two sides is formed at a corner. A clamping bar 23.42 is formed on one side of a vertical wall. An anti-falling block 25 is mounted on the lower side of the sash. The structure of the anti-falling block 25 includes: a base; the base is mounted on a sash profile; a mounting seat is protruded from the sash profile; a pulley is mounted on the mounting seat.

A hinge support 24.1 is mounted at the lower corner of a connecting position of the frame and the sash. A wind brace 26 is further mounted between the hinge support 24.1 and the sash. A groove 24.11 is formed in the end part of the hinge support 24.1, and a pin shaft hole 24.12 is formed in the hinge support 24.1. The structure of the second hinge seat 24.2 includes a first convex shaft 24.21; the first convex shaft 24.21 is mounted in the pin shaft hole 24.12 to mount the second hinge seat 24.2 in the groove 24.11. In the structure of the second hinge seat 24.2, an upward second convex shaft 24.22 and a pin hole 24.23 are further formed at one end for mounting a lower hinge.

The structure of the lower hinge includes a lower hinge block 28.1, a lower hinge body 28.2, a lower two-link rod 28.3, a lower three-link rod 28.4, and a lower clutch rod 28.5; the lower two-link rod 28.3 is mounted on a second convex shaft. The lower three-link rod 28.4 is mounted in a pin hole 24.23 of the lower hinge seat 24.2 through a pin. The lower hinge body 28.2 is connected to each of the lower two-link rod 28.3, the lower three-link rod 28.4, and the lower hinge block 28.1. The lower three-link rod 28.4 is further connected to the lower clutch rod 28.5. The other end of the lower clutch rod 28.5 is connected to the lower hinge block 28.1. The lower hinge block 28.1 is mounted on the sash profile. A clamping bar is protruded from the lower three-link rod 28.4, and the lower three-link rod 28.4 is clamped on the frame profile.

Rollers 21.12 are respectively arranged on the lower lock cylinder 23.2 and the upper lock cylinder 21.3 in a sleeving manner, so an operation is smooth during a driving process. Sliding block mounting grooves 21.13 are respectively formed in the end parts of the lower surfaces of the upper locking block 21.1 and the lower locking block 23.1. Sliding blocks made of a nylon material are mounted to match metal profiles, thereby achieving a noiseless effect.

### Embodiment 6

A working method for the hardware structure for the horizontal pivoting window in Embodiment 5, wherein

in a locked state, the handle is vertically downwards, and the upper lock point 21.4 and the lower lock seat 23.4 are respectively clamped with the upper locking block 21.1 and the lower locking block 23.1;

when the sash is switched from a locked state to a horizontally opening state, the handle is rotated to a horizontal position; the transmission strips at two ends drive downwards respectively; the upper lock point 21.4 and the lower lock seat 23.4 are respectively separated from the upper locking block 21.1 and the lower locking block 23.1; a sash is rotated to open horizontally; the safety shifting fork 21.6 is located in a safety groove 21.5 of the upper locking block 21.1, thereby achieving the purpose of preventing misoperation;

when the sash is switched from a horizontally open state to a locked state, the sash abuts a frame side, and the safety shifting fork 21.6 is separated from the safety groove 21.5 under the action of the upper lock point 21.4; the handle is rotated downwards, and then the handle is vertically downwards; the upper lock point 21.4 and the lower lock seat 23.4 are respectively clamped at the upper lock cylinder 21.3 and the lower lock cylinder 23.2;

when the sash is switched from a horizontally opening state to an inward tilting state, the sash abuts the frame side, and the safety shifting fork 21.6 is separated from the safety groove 21.5 under the action of the upper lock point 21.4; the handle is rotated upwards, and then the handle is vertically downwards; the transmission strips at the two ends drive downwards respectively; the safety shifting fork 21.6 is located in another safety groove 21.5 at the second angle sensor 22.2 on the upper side of the sash; the transmission rod 22.1 drives the roller 21.12 to be located at a gap 22.32 of the pull rod 22.3; at the structure of the first side lower locking structure, an inward tilting spring bolt 23.3 is clamped at the inclined surface 23.41 of the lower lock seat; in an inward tilting and inclining process of the window sash, the roller 21.12 is separated at the gap 22.32 at the second angle sensor 22.2, the pull rod 22.3 is connected between the frame and the sash and acts therebetween; the pull rod pin 22.31 is limited at the limiting spring, the reset rod 22.4 is connected between the pull rod 22.3 and the second angle sensor 22.2 and acts therebetween; the lower hinge seat 24.2 rotates by taking the first convex shaft 24.21 as a rotating shaft to drive the window sash to be in an inward tilting state;

when the sash is switched from an inward tilting state to a horizontally opening state or a locked state, the sash abuts the frame side vertically; the safety shifting fork 21.6 is separated from the safety groove 21.5 under the action of the upper lock point 21.4; meanwhile, the pull rod 22.3 returns under the auxiliary action of the reset rot 22.4, and the pull rod pin 22.31 relieves a limiting state; the handle is rotated downwards to horizontally open or lock the sash.

### Embodiment 7

A mounting method for the hardware hinge for the horizontal pivoting window of Embodiment 5, wherein

when a first angle sensor 21.2 is mounted, it is inserted into a longitudinal sash profile from the upper side to mount a T-shaped mounting wall 21.21 between the fifth T-shaped wall 5T and the seventh L-shaped wall 7L; a step-shaped mounting wall 1.22 sits between the fifth T-shaped wall 5T and the seventh L-shaped wall 7L of a transverse sash profile, and is inserted between the transverse sash profile and the first angle sensor 21.2 through a dual-plug 21.7, thereby completing the mounting of the first angle sensor 21.2;

when a second angle sensor 2.2 is mounted, it is inserted into the transverse sash profile from a side surface to mount a transverse l-shaped mounting wall 2.25 between the fifth T-shaped wall 5T and the seventh L-shaped wall 7L; the I-shaped mounting wall 2.24 sits between the fifth T-shaped wall 5T and the seventh L-shaped wall 7L of a longitudinal sash profile, and then is inserted between the longitudinal sash profile and the second angle sensor through a door-shaped dual-plug, thereby completing the mounting of the second angle sensor;

when a lower lock seat 3.4 is mounted, the clamping bar is hooked into the second T-shaped wall 2T of the longitudinal profile, then the other side of the clamping bar sits at a second L-shaped wall, and the lower end falls into the second T-shaped wall 2T and the second L-shaped wall 2L of the transverse frame profile and forms an embedding strip mounting groove 3.43 with the transverse profile in the transverse wall of the lower lock seat; an embedding strip penetrates into the embedding strip mounting groove to fix the lower lock seat 3.4, thereby completing the mounting of the lower lock seat 3.4.

A mounting method for a hinge seat of an upper side built-in transfer hinge and a mounting method for a hinge block of a lower side built-in transfer hinge are the same as the mounting methods for a hinge seat and a hinge block of a side hung door-window.

### Embodiment 8

A mullion connecting structure for mounting the side hung door-window of Embodiment 1 or the horizontal pivoting window of Embodiment 5 includes a two-body connecting piece, a clamping bar connecting piece, and a pop-rivet 33. The two-body connecting piece includes two parts that are connected symmetrically; the structure of each part is that: a pop-rivet half-hole 31.1 is formed in the vertical direction of a first side surface of the first base body 31, and a pin half-hole 31.2 is formed in the transverse direction of the first base body 31; a groove is formed in the side surface opposite to the first side surface; the groove is divided into a first T-shaped diversion glue groove 31.3 and a mounting groove 31.4; a diversion glue hole 31.5 which is communicated with the pop-rivet half-hole 31.1 is formed in an intersection position of the T-shaped diversion glue groove 31.3; the position of the diversion glue hole 31.5 is closer to the end part of the first base body than the position of the pin half-hole 31.2; the bottom end of a longitudinal groove of the first T-shaped diversion glue groove 31.3 is connected to the mounting groove 31.4; a diversion groove 31.6 is formed in the junction of the mounting groove 31.4 and the first T-shaped diversion glue groove 31.3, and the depth of the diversion groove 31.6 is greater than that of the mounting groove 31.4; the diversion groove 31.6 is connected to the longitudinal groove of the first T-shaped diversion glue groove 31.3, and extends through the mounting groove 31.4 to connect a second diversion glue groove 31.7 in the other side of the first base body; first convex walls 31.8 are arranged on the two surfaces adjacent to the first side surface and are flush with the upper edge, close to one end of the first T-shaped diversion glue groove 31.3, of the mounting groove 31.4; the first convex walls 31.8 extend to the bottom of the first base body 31 at one end of the second diversion glue groove 31.7; in the first base body 31, a quarter arc gap 31.9 is formed in the lower end of the first base body 31 on a surface in which the pop-rivet half-hole 31.1 is formed; a chamfer 31.10 is formed at the end part of the pop-rivet half-hole 31.1 on one surface, provided with a second rubber strip 31.7, of the first base body 31.

The pop-rivet half-holes of the two parts form a pop-rivet mounting hole, and the two parts are connected to form a two-body connecting piece.

The structure of the clamping bar connecting piece includes a second base body 32 and a pedestal 32.1. In the second base body 32, second T-shaped diversion glue grooves 32.2 are respectively formed in one pair of opposite surfaces; a diversion glue hole 31.5 is formed in one end, close to the transverse groove, in the longitudinal groove; fixing holes 32.3 which penetrate through two surfaces are formed in the other pair of opposite surfaces; the fixing holes 32.3 are communicated with the diversion glue hole 31.5; the distance between the two holes and the end part of the second base body 32 are equal; a clamping groove 32.4 is formed in one side surface, perpendicular to the longitudinal groove of the second T-shaped diversion glue groove, provided with the second T-shaped diversion glue groove 32.2; two ends of the fixing clamping bar 32.5 between the clamping grooves respectively extend in the length to form convex walls; the length of the second base body 32 in contact with the clamping groove 32.4 far away from the diversion glue hole 31.5 is the same as that of the fixing clamping bar 32.5; the convex walls are second convex walls 32.8; a groove 32.6 is formed in the lower side of the second base body 32; the pedestal 32.1 is mounted in the groove 32.6; the pedestal 32.1 is T-shaped; third diversion glue grooves 32.7 are respectively formed in the middle positions of a longitudinal part and a transverse part; the longitudinal part is mounted in the groove 32.6; the third diversion glue groove 32.7 of the longitudinal part is connected to the second T-shaped diversion glue groove 32.2; the length of the transverse part is the equal to that of the second base body 32.

The double-head pop-rivet 33 is used for cross connection. Holes 33.1 are formed in the two ends of the double-head pop-rivet; a diversion glue hole 31.5 is formed in the direction perpendicular to the direction where the holes 33.1 are located; the holes 33.1 are communicated with the diversion glue hole 31.5; the position of the diversion glue hole is closer to the end part of the pop-rivet than the positions of the holes; the pop-rivet 33 is mounted in a pop-rivet mounting hole of the two-body connecting piece; the holes 33.1 are overlapped with the hole formed by the pin half-holes 33.2; the diversion glue hole 31.5 is overlapped with the diversion glue hole 31.5 in the two-body connecting piece. The pop-rivet may also be a single-head pop-rivet. A hole and a diversion glue hole are formed in one end, and a rivet cap is arranged at the other end. The single-head pop-rivet is used for T-shaped connection.

The first T-shaped diversion glue groove, the second T-shaped diversion glue groove, the second diversion glue groove, and the third diversion glue groove are V-shaped grooves; the mounting groove is a rectangular groove.

### Embodiment 9

A connecting method for the mullion connecting structure in Embodiment 8 includes the following steps:

step 1, cutting end surfaces of a mounting profile, namely, a second profile 36, required in T-shaped connection or cross connection, into planes according to required lengths, where a fifth L-shaped wall 5L of the second profile 36 is milled to adapt to the height of the fifth L-shaped wall 5L of the first profile 35;

step 2: on the first profile 35, when the two-body connecting piece is connected, staggering the two parts of a two-body connecting body, and extruding to get close to a mounting position; connecting the two parts into a two-body connecting piece, so that the second L-shaped wall 2L outside the first cavity 34.1 is engaged with the second T-shaped wall 2T by the mounting groove 31.4; mounting the pop-rivet 33 in a pop-rivet mounting hole of the two-body connecting piece after penetrating through the first profile 35, so that a hole 33.1 in the pop-rivet is overlapped with a hole formed by the pop-rivet half-holes; at the moment, the diversion glue hole in the pop-rivet 33 is overlapped with the diversion glue hole in the two-body connecting piece; in cross connection, the double-head pop-rivet is used; in T-shaped connection, the single-head pop-rivet is used;

step 3, on the first profile 35, when the clamping bar connecting piece is connected, placing the pedestal 32.1 into the bottom of the fifth L-shaped wall 5L of the profile, and then, matching the position of the groove 32.6 in the second base body 32 and a longitudinal part of the pedestal 32.1; pushing and mounting the second base body 32 at the fifth L-shaped wall 5L of the second cavity 34.3 through the clamping grooves 32.4, and clamping a clamping bar 32.5 between the transverse wall of the fifth L-shaped wall 5L and the third T-shaped wall 3T, where the clamping grooves 32.4 respectively accommodate the transverse wall of the fifth L-shaped wall 5L and the third T-shaped wall 3T; connecting the third T-shaped wall 3T of the first profile 35 to the clamping bar connecting piece after forming the transverse wall on the outer side.

step 4, after the mounting of the two-body connecting piece and the clamping bar connecting piece is completed, mounting the profile that needs to be assembled, namely, the second profile 36; respectively sleeving the two-body connecting piece and the clamping bar connecting piece with the first cavity 34.1 and the second cavity 34.3; injecting glue into the pin hole and the fixing hole 32.3 of the two-body connecting piece and the clamping bar connecting piece:

in the two-body connecting piece, glue may penetrate through the diversion glue hole in the pop-rivet, then enter the diversion glue hole in each part, reach a second diversion glue groove 31.7 along the first T-shaped diversion glue groove 31.3, and then flow into a cavity formed at the chamber 31.10, where whether the glue is full may be determined at a half arc gap 31.9;

in the clamping bar connecting piece, the glue may penetrate through the diversion glue hole and flow to the third diversion glue groove 32.7 from the second T-shaped diversion glue groove 32.2, where whether the glue is full may be determined at the clamping groove 32.4;

step 5: after glue injection is completed, respectively fixing pins in the pin hole of the two-body connecting piece and the fixing hole 32.3 of the clamping bar connecting piece; filling the junction of the second profile heat insulating cavity 34.2 and the first profile with a sealing rubber strip; fixing the second profile 36 to form cross connection or T-shaped connection of the profiles of the door-window,

where the first profile 35 and the second profile 36 may be a frame profile and a mullion profile respectively; in the mullion profile, the structures of two sides of each of a first cavity, a first heat insulating cavity, and a second cavity are in symmetrical distribution.

### Embodiment 10

A horizontal push type pressing line clamping seat mounted in the side hung door-window of Embodiment 1 and the horizontal pivoting window of Embodiment 5 includes a base 41 and an elastic hook body 42. The base 41 and the elastic hook body 42 are integrally formed, and are made of a nylon material. A holding foot 41.1 is formed at the front end of the lower side of the base 1, the front end of the holding foot 41.1 is inclined backwards, so as to facilitate mounting; an elastic hook 41.2 is formed at the middle position of the holding foot 41.1; the holding foot 41.1 is an arc-shaped block and is solid; a concave gap 41.5 is formed in the base 41; the elastic hook 41.2 is located at the concave gap; the rear end of the holding foot 41.1 is a Z-shaped body; an outward folded hook 41.3 is arranged on the lower side of the Z-shaped body to hook the profile; an inward folded hook 41.4 is formed on the upper side of the Z-shaped body to hook a pressing line; the side surface of the elastic hook body 42 is Z-shaped; the front end of the elastic hook body is connected to the front end of the base 41, the overall elastic hook body surrounds the base 41; a crack is formed between the elastic hook body and the base 41; a hook bar 42.1 is arranged on the upper surface of the elastic hook body 42 and is engaged with a lower hook bar of the pressing line; the hook bar 42.1 is backward, and the top end of the hook bar 42.1 is a rounded corner.

### Embodiment 11

On the basis of the structure of Embodiment 10, the structure of the pressing line fixed by the clamping seat is that: the overall pressing line 43 is tubular; an external corner 43.1 is arc-shaped; the two walls connected to the external corner 43.1 are respectively outer surfaces 43.2, namely, a vertical face and a back surface 43.3; the connecting wall between the vertical face and the back surface is a bottom surface 43.4; the hook bar 43.5 is formed on the bottom surface 43.4; the direction of the hook bar 43.5 of the pressing line faces the bottom surface 43.4; a groove is formed in the inner side of the back surface 43.3; two rubber strip hook bars are formed outside the groove for fixing rubber strips.

An angle combining piece 44 penetrates into an angle combining position of the pressing line 43. The angle combining piece 44 is L-shaped. The surface of the angle combining piece 44 is matched with an inner cavity in the pressing line. The surface of the angle combining piece 44 is connected to a support wall 44.1, and is located in the groove after being mounted in the cavity of the pressing line.

### Embodiment 12

A mounting and detaching method for the horizontal push type pressing line clamping seat in Embodiment 11 includes the following steps:

firstly, regarding a glass side as an inner side, because a groove is formed in the door-window profile and L-shaped walls are formed at the two ends of the upper side of the groove, when the clamping seat is mounted in the groove, hooking the outward folded hook 41.3 on the lower side of the Z-shaped body on the sixth T-shaped wall 6T, then pressing the base 41 to make the holding foot 41.1 fall into the groove, and making the elastic hook 41.2 hook the sixth L-shaped wall 6L to complete the mounting of the clamping seat;

secondly, cutting a cross section of the pressing line into an inclination angle of 45 degrees, combining an angle by the angle combining piece 4 to form a rectangular frame;

thirdly, mounting a pressing line frame which has been combined into a rectangle on a door-window profile in a horizontal push mounting manner; in a horizontal pushing process, making the pressing line hook bar 43.5 of the pressing line move downwards elastically when being in contact with a hook bar 42.1 of the elastic hook body 42; when the pressing line hook bar 43.5 crosses the hook bar 42.1, making the hook bar 42.1 return elastically, and fixing the pressing line hook bar 43.5 under a combined action of the hook bar 42.1 and an inward folded hook bar 41.4 of the Z-shaped body;

finally, when the pressing line 3 is detached and after a glass sealing strip is detached, pressing the elastic hook body 42, namely, the position of the rear side of the elastic hook body 42, by a tool to separate the hook bar 42.1 of the elastic hook body from the pressing line hook bar 43.5, at this moment, pulling a corresponding position of the pressing line rectangular frame outwards; repeatedly pressing the subsequent elastic hook body 42, so that the pressing line rectangular frame is completely separated to complete the detaching of the pressing line. The horizontal push type pressing line clamping seat may be used secondarily.

Under the conditions of the prior art, the pressing line rectangular frame of the present disclosure may be mechanically mounted through an assembly line, so that manpower is saved.

1. A built-in transfer hinge, comprising a frame connecting block, a sash connecting block, a two-link rod, a three-link rod, a hinge body, and a clutch rod, wherein the hinge body is connected to the frame connecting block through the two-link rod and the three-link rod; the connecting positions of the two-link rod and the three-link rod on the hinge body are that: one end of the hinge body is connected to the two-link rod, the middle position of the hinge body is connected to the three-link rod, wherein the two sides of the hinge body are at a bending angle bounded by the position of the three-link rod, and the other end of the hinge body is connected to the sash connecting block; the clutch rod is further connected between the sash connecting block and the three-link rod.

2. The built-in transfer hinge according to claim 1, wherein the frame connecting block is a first hinge seat, and is mounted on a frame; the first hinge seat is that a first base body is connected to a cylindrical body, and the first base body and the cylindrical body are formed integrally; an arc-shaped hook bar is arranged at one of the two end parts of one side surface of the first base body, and an embedding mounting groove and a positioning bar are formed at the other of the two end parts of one side surface of the first base body; a groove is formed in a transverse position of the first base body; through pin holes are formed in upper walls and lower walls of two ends of the groove; a truncated position is formed on the cylindrical body, and through pin holes are respectively formed in an upper part and a lower part.

3. (canceled)

4. The built-in transfer hinge according to claim 1, wherein the sash connecting block is that a hinge block comprises a second base body; two ends of one side of the second base body respectively form into arcs; on the other side, one end part is connected to a mounting bar and a hook-shaped mounting bar, and the other part is provided with a protrusion part and a first pin hole; a second pin hole is formed in the second base body close to the first pin hole; gaps are formed in the centers of the positions of the first pin hole and the second pin hole; a gap position is also formed on the hook-shaped mounting bar.

5. (canceled)

6. The built-in transfer hinge according to claim 1, wherein in the frame, the structure of a frame profile comprises: a first cavity, a first heat insulating cavity, and a second cavity; a first L-shaped wall and a second L-shaped wall respectively extend from two sides of an outer side wall of the first cavity; a first T-shaped wall and a second T-shaped wall respectively extend from two sides of a wall between the first cavity and the first heat insulating cavity; a third L-shaped wall extends from a wall between the second cavity and the first heat insulating cavity; a fourth L-shaped wall and a fifth L-shaped wall extend from an outer side wall of the second cavity;
in the sash, the structure of a sash profile comprises: a third cavity, a second heat insulating cavity, and a fourth cavity; a sixth L-shaped wall extends from one of two sides of an outer side wall of the third cavity, and a hook-shaped wall extends from the other side of the two sides of the outer side wall of the third cavity; a fourth T-shaped wall is arranged on the hook-shaped wall; a fifth T-shaped wall and a sixth T-shaped wall respectively extend from a wall between the third cavity and the second heat insulating cavity; a seventh L-shaped wall is arranged close to the hook-shaped wall between the fifth T-shaped wall and the hook-shaped wall; a concave groove is formed towards the cavity in the inner wall surface of the third cavity between the fifth T-shaped wall and the hook-shaped wall; an eighth L-shaped wall is formed on a wall between the second heat insulating cavity and the fourth cavity; the outer side wall of the fourth cavity extends to form a ninth L-shaped wall.

7. The built-in transfer hinge according to claim 6, wherein first convex walls are respectively arranged at the opposite positions of the first L-shaped wall and the first T-shaped wall; a third T-shaped wall is arranged on the fifth L-shaped wall; a seventh T-shaped wall is formed on the ninth L-shaped wall; the second heat insulating cavity is externally connected to a sealing bar.

8. A side hung door-window mounted with the built-in transfer hinge according to claim 1, comprising a frame and a sash, wherein the frame is connected to the sash through the built-in transfer hinge;
in the first hinge seat, the arc-shaped hook bar is connected to the interior of the second L-shaped wall; an embedding strip is mounted in the embedding mounting groove, and the embedding mounting groove is fixed to the interior of the second T-shaped wall; a positioning bar is protruded at the position, in contact with the second L-shaped wall, on the first base body;
in the hinge block, two ends of one side of the second base body respectively form into arcs which are mounted between the fourth T-shaped wall and the seventh L-shaped wall; the mounting bar is mounted inside a transverse section of the seventh L-shaped wall; the hook-shaped mounting bar is mounted at the fifth T-shaped wall; solid walls with the same structures as that of the fifth T-shaped wall are formed in the hook-shaped parts at the two ends of the gap position formed by the hook-shaped mounting bar, and the solid walls are limiting fixing structures; the hinge block is fixed by a T-shaped embedding block within the space formed by the hook-shaped mounting bar and a wall of the fourth cavity;
the two-link rod and the three-link rod are respectively U-shaped, and pin holes are respectively formed in transverse walls and end parts, wherein clutch rod connecting pin holes are further formed in the inner sides of the end parts of the three-link rod; a pin is mounted in a pin hole in the transverse wall of the two-link rod and a pin hole in the cylindrical body in a matched manner; a pin is mounted in an end part pin hole and a two-link rod connecting pin hole in the hinge body in a matched manner; a pin is mounted in a pin hole in the transverse wall of the three-link rod and a pin hole in the first base body in a matched manner; a pin is mounted in the end part pin hole and a three-link rod connecting pin hole in the hinge body in a matched manner; a position opening is formed in the position, corresponding to the two-link rod, in the wall of the second heat insulating cavity in the sash profile;
in a gap part of the hinge block, a pin is mounted in a first pin hole and a pin hole in one end of a clutch rod in a matched manner; a pin is mounted in a pin hole in the other end of the clutch rod and the clutch rod connecting pin hole of the three-link rod in a matched manner; a pin is mounted in a second pin and a hinge body connecting pin hole in a matched manner.

9. The side hung door-window mounted with the built-in transfer hinge according to claim 8, wherein the embedding strip comprises a first transverse wall connected to a longitudinal wall and then connected to a second transverse wall; the second transverse wall is connected to a detaching wall; the length of the detaching wall is less than that of the overall embedding strip; a detaching working hole is further formed in the first base body; after the embedding strip is mounted, the detaching wall is located at a slightly upper part of the detaching working hole; the length of a formation part of a hinge block connecting pin hole is greater than that of other parts of a body.

10. A mullion connecting structure, comprising a two-body connecting piece, a clamping bar connecting piece, and a pop-rivet, wherein the two-body connecting piece comprises two parts that are connected symmetrically; the structure of each part is that: a vertical pop-rivet half-hole is formed in a first side surface of the first base body, and a pin half-hole is formed in the transverse direction of the first base body; a groove is formed in the side surface opposite to the first side surface; the groove is divided into a first T-shaped diversion glue groove and a mounting groove; a diversion glue hole which is communicated with the pop-rivet half-hole is formed in an intersection position of the first T-shaped diversion glue groove; the bottom end of a longitudinal groove of the first T-shaped diversion glue groove is connected to the mounting groove; a diversion groove is formed in the junction of the mounting groove and the first T-shaped diversion glue groove, and the depth of the diversion groove is greater than that of the mounting groove; the diversion groove is connected to the longitudinal groove of the first T-shaped diversion glue groove, and extends through the mounting groove to connect a second diversion glue groove in the other side of the first base body; first convex walls are arranged on the two surfaces adjacent to the first side surface and are flush with the upper edge, close to one end of the first T-shaped diversion glue groove, of the mounting groove; the first convex walls extend to the bottom of the first base body at one end of the second diversion glue groove; the pop-rivet half-holes of the two parts form a pop-rivet mounting hole, and the two parts are connected to form a two-body connecting piece;
the structure of the clamping bar connecting piece comprises a second base body and a pedestal; in the second base body, second T-shaped diversion glue grooves are respectively formed in one pair of opposite surfaces; a diversion glue hole is formed in one end, close to a transverse groove, in the longitudinal groove; fixing holes which penetrate through two surfaces are formed in the other pair of opposite surfaces; the fixing holes are communicated with the diversion glue hole; clamping grooves are formed in one side surface, perpendicular to the longitudinal groove of the second T-shaped diversion glue groove, provided with the second T-shaped diversion glue groove; two ends of the fixing clamping bar between the clamping grooves respectively extend in the length to form convex walls, the length of the second base body in contact with the clamping groove far away from the diversion glue hole is the same as that of the fixing clamping bar, and the convex walls are second convex walls; a slot is formed in the lower side of the second base body; the pedestal is mounted in the slot; the pedestal is T-shaped; third diversion glue grooves are respectively formed in the middle positions of a longitudinal part and a transverse part; the longitudinal part is mounted in the slot; the third diversion glue groove of the longitudinal part is connected to the second T-shaped diversion glue groove; the length of the transverse part is the same as that of the second base body;
a pop-rivet is a double-head pop-rivet: holes are formed in two ends; the diversion glue hole is formed in the direction perpendicular to the direction where the holes are located; the holes are communicated with the diversion glue hole; the pop-rivet is mounted in the pop-rivet mounting hole of the two-body connecting piece; the holes are overlapped with the hole formed by the pin half-holes; the diversion glue hole is overlapped with the diversion glue hole in the two-body connecting piece.

11. The mullion connecting structure according to claim 10, wherein in the first base body, a quarter arc gap is formed in the lower end of the first base body on a surface in which the pop-rivet half-hole is formed; the first T-shaped diversion glue groove, the second T-shaped diversion glue groove, the second diversion glue groove, and the third diversion glue groove are V-shaped grooves; the mounting groove is a rectangular groove; a chamfer is formed at the end part of the pop-rivet half-hole on one surface, provided with the second diversion glue groove, of the first base body.

12. The mullion connecting structure according to claim 11, wherein in the two-body connecting piece, the position of the diversion glue hole is closer to the end part of the first base body than the position of the pin half-hole; in the clamping bar connecting piece, the distance between the position of the diversion glue hole and the end part of the second base body is equal to that between the position of the fixing hole and the second base body; in the pop-rivet, the position of the diversion glue hole is closer to the end part of the pop-rivet than the position of the hole.

13. The mullion connecting structure according to claim 10, wherein the pop-rivet is a single-head pop-rivet: a hole and a diversion glue hole are formed in one end, and a rivet cap is arranged at the other end.

14. A horizontal push type pressing line clamping seat, comprising a base and an elastic hook body; a holding foot is formed at the front end of the lower side of the base, and an elastic hook is formed in the middle position of the holding foot; a Z-shaped body is arranged at the rear end of the lower side of the base; an outward folded hook is formed on the lower side of the Z-shaped body; an inward folded hook is formed on the upper side of the Z-shaped body; the side surface of the elastic hook body is Z-shaped; the front end of the elastic hook body is connected to the front end of the base, the overall elastic hook body surrounds the base; a crack is formed between the elastic hook body and the base; a hook bar is arranged on the upper surface of the elastic hook body.

15. The horizontal push type pressing line clamping seat according to claim 14, wherein the base and the elastic hook body are integrally formed and are made of a nylon material; the holding foot is an arc-shaped block; a concave gap is formed in the base; the elastic hook is located at the concave gap; the front end of the holding foot is inclined backwards; the direction of the hook bar is backward; a rounded corner is formed at the top end of the hook bar.

16. The horizontal push type pressing line clamping seat according to claim 14, wherein the structure of a pressing line fixed by the clamping seat is that: the overall pressing line is tubular; an external corner is arc-shaped; the two walls connected to the external corner are respectively an outer surface and a back surface; the connecting wall between the outer surface and the back surface is a bottom surface; a hook bar is formed on the bottom surface; the direction of the hook bar of the pressing line faces the bottom surface; a groove is formed in the inner side of the back surface; two rubber strip hook bars are formed outside the groove.

17. The horizontal push type pressing line clamping seat according to claim 16, wherein an angle combining piece is penetrated into a pressing line angle combining position; the angle combining piece is L-shaped; the surface of the angle combining piece is matched with a cavity in the pressing line; the surface of the angle combining piece is connected to a support wall; the angle combining piece is located in the groove after being mounted in the cavity of the pressing line.

18. (canceled)

19. (canceled)

20. A mounting and detaching method for the horizontal push type pressing line clamping seat according to claim 17, comprising the following steps:
firstly, regarding a glass side as an inner side, because a groove is formed in the door-window profile and L-shaped walls are formed at the two ends of the upper side of the groove, when the clamping seat is mounted in the groove, making the outward folded hook on the lower side of the Z-shaped body hook the sixth T-shaped wall, then pressing the base, making the holding foot fall into the groove, and hooking the sixth L-shaped wall by the elastic hook to complete the mounting of the clamping seat;
secondly, cutting a cross section of the pressing line into an inclination angle of 45 degrees, combining an angle by the angle combining piece to form a rectangular frame;
thirdly, mounting a pressing line frame which has been combined into a rectangle on a door-window profile in a horizontal push mounting manner; in a horizontal pushing process, making a pressing line hook bar of the pressing line move downwards elastically when the pressing line hook bar of the pressing line is in contact with a hook bar of an elastic hook body; when the pressing line hook bar crosses the hook bar of the elastic hook body, making the hook bar of the elastic hook body return, and fixing the pressing line hook bar under a combined action of the hook bar of the elastic hook body and an inward folded hook bar of the Z-shaped body;
finally, when the pressing line is detached and after a glass sealing strip is detached, pressing the elastic hook body by a tool, separating the hook bar of the elastic hook body from the pressing line hook bar, at this moment, the pressing line may be separated by pulling corresponding positions of the pressing line rectangular frame outwards; repeatedly pressing the subsequent elastic hook body, so that the pressing line rectangular frame is completely separated to complete the detaching of the pressing line.

21. A hardware structure for a horizontal pivoting window, comprising a frame and a sash, wherein a hardware transmission structure comprises a handle; a transmission structure is connected from the handle to the interior of the profile of the sash; two ends of the transmission structure are connected to transmission strips; the upper transmission strip is connected to a first side upper locking structure at an upper corner of the sash; the lower transmission strip is connected to a first side lower locking structure at a lower corner of the sash;
in the first side upper locking structure, the upper transmission strip is connected to an upper locking block through a pin shaft and pin hole matched structure; the other end of the upper locking block penetrates into a first angle sensor, and drives within the first angle sensor;
an upper lock cylinder is arranged at an edge position on the upper locking block, and an upper lock point is mounted on the frame corresponding to a locking position of the upper lock cylinder; an upper locking block penetrates into one end in a first angle sensor; multiple safety grooves are formed in an outer surface of the upper locking block; a safety shifting fork further extends out from the first angle sensor; a bulge is formed at an extension end of the safety shifting fork and is matched in the safety groove; at a safety shifting fork mounting position, a waist-shaped groove is formed in the first angle sensor, and a buckle cover is mounted on the waist-shaped groove; a convex shaft is formed in the waist-shaped groove; a cylindrical bulge is formed close to the convex shaft, the safety shifting fork is mounted on the convex shaft, and two limiting bulges are further formed on the safety shifting fork; a spring bypasses the cylindrical bulge; two ends of the spring are clamped between the two limiting bulges; in the first angle sensor, a transmission belt which is connected to an upper locking block bypasses the first angle sensor and is connected to a transmission strip on the upper side of the sash; the transmission strip is connected to a transmission rod; the transmission rod drives in the second angle sensor;
on a second angle sensor, a pull rod is mounted, and one end of the pull rod is assembled and connected to a built-in transfer hinge on the upper side; an arc-shaped notch is formed in one side of the upper surface of the second angle sensor; a waist-shaped groove is formed adjacent to the arc-shaped notch; one end of a limiting spring is mounted in the arc-shaped notch, and the other end of the limiting spring penetrates into the waist-shaped groove and forms elastic limiting; a pull rod pin is arranged in the limiting spring in a sleeving manner; the pull rod pin is fixedly connected to the pull rod; the middle position of the upper surface of the second angle sensor is connected to a reset rod; the other end of the reset rod is connected to the lower surface of the pull rod; a strip-shaped groove is formed in the other side of the upper surface of the second angle sensor; the transmission rod drives at the bottom of the strip-shaped groove; a bulge is formed on the transmission rod; the bulge is located at the bottom of the strip-shaped groove; a cylindrical shaft is formed on the bulge; a roller is arranged on the cylindrical shaft in a sleeving manner; a strip-shaped groove is further formed in the position, corresponding to the strip-shaped groove, on the lower surface of the pull rod; an outward gap is formed in the one side, facing the reset rod, in the strip-shaped groove of the pull rod; the roller rolls in the strip-shaped groove of the pull rod, and is separated from the pull rod at the gap;
in the first side lower locking structure, a transmission strip is connected to a lower locking block; a lower lock cylinder is arranged at an edge position on the lower locking block; an inward tilting spring bolt extends from the lower side of the lower lock cylinder; a lower lock seat is mounted at the position, corresponding to the locking position of the lower locking block, on the frame;
a lower side built-in transfer hinge is mounted at the lower corner of the junction of the frame and the sash; a hinge support is mounted on the frame and is mounted in a manner of matching a second hinge seat.

22. The hardware structure for a horizontal pivoting window according to claim 21, wherein a locking bulge is formed on an upper lock point; the overall structure of the lower lock seat is L-shaped; the upper end of the lower lock seat is connected to the locking bulge; an inclined surface for connecting two sides is formed at a corner, and a clamping bar is formed on one side of a vertical wall; rollers are respectively arranged on the lower lock cylinder and the upper lock cylinder in a sleeving manner; lock sliding block mounting grooves are respectively formed in the edges of the lower surfaces of the upper locking block and the lower locking block, and are used for mounting sliding blocks made of a nylon material.

23. The hardware structure for a horizontal pivoting window according to claim 21, wherein an anti-falling block is mounted on the lower side of the sash; the structure of the anti-falling block comprises: a base; the base is mounted on a sash profile; a mounting seat is protruded from the sash profile; a pulley is mounted on the mounting seat; a wind brace is further mounted between the hinge support and the sash.

24. The hardware structure for a horizontal pivoting window according to claim 21, wherein in the mounting ends of the first angle sensor, a mounting position at one end comprises two T-shaped mounting walls, and a mounting position at the other end comprises two step-shaped mounting walls; a mounting position at one end of the second angle sensor comprises an I-shaped mounting wall; a mounting position at the other end of the second angle sensor comprises a protruded transverse l-shaped mounting wall.

25. The hardware structure for a horizontal pivoting window according to claim 21, further comprising a mullion connecting structure, wherein the mullion connecting structure comprises: a two-body connecting piece, a clamping bar connecting piece, and a pop-rivet, wherein the two-body connecting piece comprises two parts that are connected symmetrically; the structure of each part is that: a vertical pop-rivet half-hole is formed in a first side surface of the first base body, and a pin half-hole is formed in the transverse direction of the first base body; a groove is formed in the side surface opposite to the first side surface; the groove is divided into a first T-shaped diversion glue groove and a mounting groove; a diversion glue hole which is communicated with the pop-rivet half-hole is formed in an intersection position of the first T-shaped diversion glue groove; the bottom end of a longitudinal groove of the first T-shaped diversion glue groove is connected to the mounting groove; a diversion groove is formed in the junction of the mounting groove and the first T-shaped diversion glue groove, and the depth of the diversion groove is greater than that of the mounting groove; the diversion groove is connected to the longitudinal groove of the first T-shaped diversion glue groove, and extends through the mounting groove to connect a second diversion glue groove in the other side of the first base body; first convex walls are arranged on the two surfaces adjacent to the first side surface and are flush with the upper edge, close to one end of the first T-shaped diversion glue groove, of the mounting groove; the first convex walls extend to the bottom of the first base body at one end of the second diversion glue groove; the pop-rivet half-holes of the two parts form a pop-rivet mounting hole, and the two parts are connected to form a two-body connecting piece;
the structure of the clamping bar connecting piece comprises a second base body and a pedestal; in the second base body, second T-shaped diversion glue grooves are respectively formed in one pair of opposite surfaces; a diversion glue hole is formed in one end, close to a transverse groove, in the longitudinal groove; fixing holes which penetrate through two surfaces are formed in the other pair of opposite surfaces; the fixing holes are communicated with the diversion glue hole; clamping grooves are formed in one side surface, perpendicular to the longitudinal groove of the second T-shaped diversion glue groove, provided with the second T-shaped diversion glue groove; two ends of the fixing clamping bar between the clamping grooves respectively extend in the length to form convex walls, the length of the second base body in contact with the clamping groove far away from the diversion glue hole is the same as that of the fixing clamping bar, and the convex walls are second convex walls; a slot is formed in the lower side of the second base body; the pedestal is mounted in the slot; the pedestal is T-shaped; third diversion glue grooves are respectively formed in the middle positions of a longitudinal part and a transverse part; the longitudinal part is mounted in the slot; the third diversion glue groove of the longitudinal part is connected to the second T-shaped diversion glue groove; the length of the transverse part is the same as that of the second base body;
a pop-rivet is a double-head pop-rivet: holes are formed in two ends; the diversion glue hole is formed in the direction perpendicular to the direction where the holes are located; the holes are communicated with the diversion glue hole; the pop-rivet is mounted in the pop-rivet mounting hole of the two-body connecting piece; the holes are overlapped with the hole formed by the pin half-holes; the diversion glue hole is overlapped with the diversion glue hole in the two-body connecting piece.

26. The hardware structure for a horizontal pivoting window according to claim 21, further comprising a horizontal push type pressing line clamping seat, wherein the structure of the horizontal push type pressing line clamping seat comprises: a base and an elastic hook body; a holding foot is formed at the front end of the lower side of the base, and an elastic hook is formed in the middle position of the holding foot; a Z-shaped body is arranged at the rear end of the lower side of the base; an outward folded hook is formed on the lower side of the Z-shaped body; an inward folded hook is formed on the upper side of the Z-shaped body; the side surface of the elastic hook body is Z-shaped; the front end of the elastic hook body is connected to the front end of the base, the overall elastic hook body surrounds the base; a crack is formed between the elastic hook body and the base; a hook bar is arranged on the upper surface of the elastic hook body.

27. A mounting method for the hardware structure for a horizontal pivoting window according to claim 21, comprising the following steps:
when a first angle sensor is mounted, inserting the first angle sensor into a longitudinal sash profile from an upper side to mount a T-shaped mounting wall between a fifth T-shaped wall and a seventh L-shaped wall; making step-shaped mounting walls sit between the fifth T-shaped wall and the seventh L-shaped wall of a transverse sash profile, and inserting the step-shaped mounting walls between the transverse sash profile and the first angle sensor through a dual-plug, so as to fix the first angle sensor to the sash profile, thereby completing the mounting of the first angle sensor;
when a second angle sensor is mounted, inserting the second angle sensor into a transverse sash profile from a side surface to mount a transverse l-shaped mounting wall between a fifth T-shaped wall and a seventh L-shaped wall; making an I-shaped mounting wall sit between the fifth T-shaped wall and the seventh L-shaped wall of a longitudinal sash profile, and then inserting the I-shaped mounting wall between the longitudinal sash profile and the second angle sensor through a door-shaped dual-plug, so as to fix the second angle sensor to the sash profile, thereby completing the mounting of the second angle sensor;
when a lower lock seat is mounted, hooking a clamping bar into a second T-shaped wall of the longitudinal profile, then making the other side of the lower lock seat sit into a second L-shaped wall, and making the lower end fall into a second T-shaped wall and a second L-shaped wall of a transverse frame profile, penetrating an embedding strip for fixing, thereby completing the mounting of the lower lock seat,
wherein a mounting method for a hinge seat of an upper side built-in transfer hinge, and a mounting method for a hinge block of a lower side built-in transfer hinge, and a mounting method for a first hinge seat and a hinge block of a side hung door-window are the same.

28. The mounting method for the hardware structure for the horizontal pivoting window according to claim 27, wherein a connecting method for a mullion connecting structure comprises:
step 1, cutting end surfaces of a mounting profile, namely, a second profile, required in T-shaped connection or cross connection, into planes according to required lengths, wherein the fifth L-shaped wall of the second profile is milled to adapt to the height of the fifth L-shaped wall of a first profile;
step 2: on a first profile, when the two-body connecting piece is connected, staggering the two parts of a two-body connecting body, and extruding to get close to a mounting position; connecting the two parts into the two-body connecting piece, making the second L-shaped wall engage with the second T-shaped wall outside the first cavity by the mounting groove; mounting the pop-rivet in the pop-rivet mounting hole of the two-body connecting piece after the pop-rivet penetrates through the first profile, and overlapping a hole of the pop-rivet with a hole formed by the pop-rivet half-holes, wherein a diversion glue hole in the pop-rivet is overlapped with a diversion glue hole in the two-body connecting piece; in cross connection, a double-head pop-rivet is used; in T-shaped connection, the single-head pop-rivet is used;
step 3, on the first profile, when the clamping bar connecting piece is connected, placing the pedestal into the bottom of the fifth L-shaped wall of the profile, and then, matching the position of the groove in the second base body and a longitudinal part of the pedestal; pushing and mounting the second base body at the fifth L-shaped wall of the second cavity through the clamping grooves, and clamping a fixing clamping bar between the transverse wall of the fifth L-shaped wall and the third T-shaped wall, wherein the clamping grooves respectively accommodate the transverse wall of the fifth L-shaped wall and the third T-shaped wall;
step 4, after the mounting of the two-body connecting piece and the clamping bar connecting piece is completed, mounting the profile that needs to be assembled, namely, the second profile; respectively sleeving the two-body connecting piece and the clamping bar connecting piece with the first cavity and the second cavity; respectively injecting glue into the pin hole and the fixing hole of the two-body connecting piece and the clamping bar connecting piece:
in the two-body connecting piece, glue may penetrate through the diversion glue hole in the pop-rivet, then enter the diversion glue hole in each part, reach a second diversion glue groove along the first T-shaped diversion glue groove, and then flow into a cavity formed at the chamber; whether the glue is full may be determined at a half arc gap;
in the clamping bar connecting piece, the glue may penetrate through the diversion glue hole and flow to the third diversion glue groove from the second T-shaped diversion glue groove; whether the glue is full may be determined at the clamping groove;
step 5: after glue injection is completed, respectively fixing pins in the pin hole of the two-body connecting piece and the fixing hole of the clamping bar connecting piece; fixing the second profile to form cross connection or T-shaped connection of profiles of a door-window.

29. The mounting method for the hardware structure for the horizontal pivoting window according to claim 27, wherein a mounting and detaching method for a horizontal push type pressing line clamping seat comprises:
firstly, regarding a glass side as an inner side, because a groove is formed in the door-window profile and L-shaped walls are formed at the two ends of the upper side of the groove, when the clamping seat is mounted in the groove, making the outward folded hook on the lower side of the Z-shaped body hook the sixth T-shaped wall, then pressing the base, making the holding foot fall into the groove, and hooking the sixth L-shaped wall by the elastic hook to complete the mounting of the clamping seat;
secondly, cutting a cross section of the pressing line into an inclination angle of 45 degrees, combining an angle by the angle combining piece to form a rectangular frame;
thirdly, mounting a pressing line frame which has been combined into a rectangle on a door-window profile in a horizontal push mounting manner; in a horizontal pushing process, making a pressing line hook bar of the pressing line move downwards elastically when the pressing line hook bar of the pressing line is in contact with a hook bar of an elastic hook body; when the pressing line hook bar crosses the hook bar of the elastic hook body, making the hook bar of the elastic hook body return, and fixing the pressing line hook bar under a combined action of the hook bar of the elastic hook body and an inward folded hook bar of the Z-shaped body;
finally, when the pressing line is detached and after a glass sealing strip is detached, pressing the elastic hook body by a tool, separating the hook bar of the elastic hook body from the pressing line hook bar, at this moment, the pressing line may be separated by pulling corresponding positions of the pressing line rectangular frame outwards; repeatedly pressing the subsequent elastic hook body, so that the pressing line rectangular frame is completely separated to complete the detaching of the pressing line.

30. A mounting method for the side hung door-window mounted with the built-in transfer hinge according to claim 6, comprising the following steps:
step 1: movably and fixedly mounting each of a first hinge seat, a hinge body, a hinge block, a two-link rod, a three-link rod, and a clutch rod by mounting pins in pin holes, so as to complete the assembling the overall hinge;
step 2: forming a notch with the same length as the positioning bar in a transverse wall of a second T-shaped wall at the position, corresponding to the positioning bar, where the first hinge seat is mounted on the frame; firstly, clamping the arc-shaped hook bar into a second L-shaped wall, and rotating a first base body around the arc-shaped hook bar to make a cylindrical body abut the second T-shaped wall; simultaneously, mounting the positioning bar into the notch, and penetrating the embedding strip into the embedding mounting groove, thereby mounting the first hinge seat on a frame profile;
step 3: at the position where the hinge block is mounted on the sash, clamping the hook-shaped mounting bar on the fifth T-shaped wall, and simultaneously, matching a solid wall structure with the fifth T-shaped wall; simultaneously, mounting an arc-shaped end part between the fourth T-shaped wall and the seventh L-shaped wall, and mounting a mounting bar inside the transverse section of the seventh L-shaped wall; penetrating the T-shaped embedding block into a space formed by the hook-shaped mounting bar and a wall of the fourth cavity to fix the hinge block; clamping the T-shaped embedding block between the fifth T-shaped wall and the mounting bar to mount the hinge block on the sash profile, thereby mounting the built-in transfer hinge on the side hung door-window to complete the mounting between the frame and the sash; in addition, when the first hinge seat is detached, penetrating a screw into the detaching working hole, and rotating to eject the embedding strip out.

31. A connecting method for the mullion connecting structure according to claim 13, comprising the following steps:
step 1, cutting end surfaces of a mounting profile, namely, a second profile, required in T-shaped connection or cross connection, into planes according to required lengths, wherein the fifth L-shaped wall of the second profile is milled to adapt to the height of the fifth L-shaped wall of a first profile;
step 2: on a first profile, when the two-body connecting piece is connected, staggering the two parts of a two-body connecting body, and extruding to get close to a mounting position;
connecting the two parts into the two-body connecting piece, making the second L-shaped wall engage with the second T-shaped wall outside the first cavity by the mounting groove; mounting the pop-rivet in the pop-rivet mounting hole of the two-body connecting piece after the pop-rivet penetrates through the first profile, and overlapping a hole of the pop-rivet with a hole formed by the pop-rivet half-holes, wherein a diversion glue hole in the pop-rivet is overlapped with a diversion glue hole in the two-body connecting piece; in cross connection, a double-head pop-rivet is used; in T-shaped connection, the single-head pop-rivet is used;
step 3, on the first profile, when the clamping bar connecting piece is connected, placing the pedestal into the bottom of the fifth L-shaped wall of the profile, and then, matching the position of the groove in the second base body and a longitudinal part of the pedestal; pushing and mounting the second base body at the fifth L-shaped wall of the second cavity through the clamping grooves, and clamping a fixing clamping bar between the transverse wall of the fifth L-shaped wall and the third T-shaped wall, wherein the clamping grooves respectively accommodate the transverse wall of the fifth L-shaped wall and the third T-shaped wall;
step 4, after the mounting of the two-body connecting piece and the clamping bar connecting piece is completed, mounting the profile that needs to be assembled, namely, the second profile; respectively sleeving the two-body connecting piece and the clamping bar connecting piece with the first cavity and the second cavity; respectively injecting glue into the pin hole and the fixing hole of the two-body connecting piece and the clamping bar connecting piece:
in the two-body connecting piece, glue may penetrate through the diversion glue hole in the pop-rivet, then enter the diversion glue hole in each part, reach a second diversion glue groove along the first T-shaped diversion glue groove, and then flow into a cavity formed at the chamber; whether the glue is full may be determined at a half arc gap;
in the clamping bar connecting piece, the glue may penetrate through the diversion glue hole and flow to the third diversion glue groove from the second T-shaped diversion glue groove; whether the glue is full may be determined at the clamping groove;
step 5: after glue injection is completed, respectively fixing pins in the pin hole of the two-body connecting piece and the fixing hole of the clamping bar connecting piece; fixing the second profile to form cross connection or T-shaped connection of profiles of a door-window.

32. The hardware structure for a horizontal pivoting window according to claim 21, wherein the frame connecting block comprises the hinge support and the second hinge seat; a groove is formed in the end part of the hinge support, and a pin shaft hole is formed in the hinge support; the structure of the second hinge seat comprises a first convex shaft; the first convex shaft is mounted in the pin shaft hole to mount the second hinge seat in the groove; in the structure of the second hinge seat, an upward second convex shaft and a pin hole are further formed in one end; the two-link rod is mounted on the second convex shaft; the three-link rod is mounted in the pin hole of the second hinge seat.

33. The hardware structure for a horizontal pivoting window according to claim 21, wherein the sash connecting block is a pull rod, and the pull rod is connected between the clutch rod and the hinge body.
